(19) United States
(12) Patent Application Publication
(10) Pub. No.: US 2001/0029530 A1
(43) Pub. Date: Oct. 11, 2001

(54) System and method of managing resource in network system

(76) Inventors: Yoshiko Naito, Kanagawa (JP); Tsuneaki Kurumida, Kanagawa (JP); Tetsuo Sakai, Kanagawa (JP); Hideo Ikeno, Kanagawa (JP); Jun Horiyama, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/795,129

(22) Filed: Mar. 1, 2001

(30) Foreign Application Priority Data
Mar. 3, 2000 (JP) 2000-059190
Apr. 19, 2000 (JP) 2000-118038

(51) Int. Cl. G06F 15/173

(52) U.S. Cl. 709/223

(57) ABSTRACT

A network system comprising a plurality of peripheral devices, a resource updating apparatus for updating resources used by the peripheral devices and a resource manager apparatus for managing the resources being respectively connected via a network is provided. The resource manager apparatus comprises means for storing setting information indicating relation between each of the peripheral devices and resources set thereon, means for, when resources of one of said peripheral devices are updated, searching for the others concerning the updated resource on the basis of the setting information, and means for notifying said resource updating apparatus that resources of the searched peripheral device should be updated.

### FIELD OF THE INVENTION

The present invention mainly relates to a technique of managing a resource in a network system.

### BACKGROUND OF THE INVENTION

Conventionally in a network system, resources such as fonts, external characters, and forms are registered in respective peripheral devices such as a printer and function composite type copying machine, or client PCs (personal computers).

When a resource is to be changed in an environment in which a plurality of peripheral devices are managed, correspondences between peripheral devices and resources are individually managed by the manager of these peripheral devices or the user of a client PC, and the resources of the peripheral devices may not be completely synchronized.

For this reason, synchronization sometimes becomes imperfect. A document confirmed on a client PC may be different from, e.g., a document printed by a peripheral device, or printing results are different between peripheral devices.

### SUMMARY OF THE INVENTION

It is an object of the present invention to provide a system and method capable of unitarily managing resources used in a network system.

According to the present invention, there is provided a network system comprising a plurality of peripheral devices, a resource updating apparatus for updating resources used by said peripheral devices and a resource manager apparatus for managing the resources being respectively connected via a network, wherein said resource manager apparatus comprises

means for storing setting information indicating relation between each of said peripheral devices and resources set thereon,

means for, when resources of one of said peripheral devices are updated, searching for the others concerning the updated resource on the basis of the setting information, and

means for notifying said resource updating apparatus that resources of said searched peripheral device should be updated.

According to the present invention, there is provided a resource manager apparatus communicating with a plurality of peripheral devices and a resource updating apparatus for updating resources used by said peripheral devices and managing the resources, comprising

means for storing setting information indicating relation between each of said peripheral devices and resources set thereon,

means for, when resources of one of said peripheral devices are updated, searching for the others concerning the updated resource on the basis of the setting information, and

means for notifying said resource updating apparatus that resources of said searched peripheral device should be updated.

According to the present invention, there is provided a resource managing method executed on a system comprising a plurality of peripheral devices and a resource updating apparatus for updating resources used by said peripheral devices being respectively connected, comprising the steps of

searching, when resources of one of said peripheral devices are updated, for the others concerning the updated resource on the basis of setting information indicating relation between each of said peripheral devices and resources set thereon, and

notifying said resource updating apparatus that resources of said searched peripheral device should be updated.

According to the present invention, there is provided a recording medium which records a resource managing program for executed on a system comprising a plurality of peripheral devices and a resource updating apparatus for updating resources used by said peripheral devices being respectively connected, said resource managing program allowing a computer to execute the steps of

searching, when resources of one of said peripheral devices are updated, for the others concerning the updated resource on the basis of setting information indicating relation between each of said peripheral devices and resources set thereon, and

notifying said resource updating apparatus that resources of said searched peripheral device should be updated.

According to the present invention, there is provided a resource managing program for executed on a system comprising a plurality of peripheral devices and a resource updating apparatus for updating resources used by said peripheral devices being respectively connected, said resource managing program allowing a computer to execute the steps of

searching, when resources of one of said peripheral devices are updated, for the others concerning the updated resource on the basis of setting information indicating relation between each of said peripheral devices and resources set thereon, and

notifying said resource updating apparatus that resources of said searched peripheral device should be updated.

According to the present invention, there is provided a network system comprising a peripheral device, computers, a resource updating apparatus for updating resources used by said peripheral device or said computers and a resource manager apparatus for managing the resources being respectively connected via a network, wherein said resource manager apparatus comprises

means for storing setting information indicating relation between each of said computers and resources set thereon,

means for, when resources of said peripheral device or one of said computers are updated, searching for the other computers concerning the updated resource on the basis of the setting information, and

means for notifying the searched computer that resources have been updated.

According to the present invention, there is provided a resource manager apparatus communicating with a peripheral device, computers, and a resource updating apparatus for updating resources used by said peripheral device or said computers and managing the resources, comprising

means for storing setting information indicating relation between each of said computers and resources set thereon,

means for, when resources of said peripheral device or one of said computers are updated, searching for the other computers concerning the updated resource on the basis of the setting information, and

means for notifying the searched computer that resources have been updated.

According to the present invention, there is provided a resource managing method executed on a system comprising a peripheral device, computers, and a resource updating apparatus for updating resources used by said peripheral device or said computers being respectively connected, comprising the steps of

storing setting information indicating relation between each of said computers and resources set thereon,

searching, when resources of said peripheral device or one of said computers are updated, for the other computers concerning the updated resource on the basis of the setting information, and

notifying the searched computer that resources have been updated.

According to the present invention, there is provided a recording medium which records a resource managing program for executed on a system comprising a peripheral device, computers, and a resource updating apparatus for updating resources used by said peripheral device or said computers being respectively connected, said resource managing program allowing a computer to execute the steps of

storing setting information indicating relation between each of said computers and resources set thereon,

searching, when resources of said peripheral device or one of said computers are updated, for the other computers concerning the updated resource on the basis of the setting information, and

notifying the searched computer that resources have been updated.

According to the present invention, there is provided a resource managing program for executed on a system comprising a peripheral device, computers, and a resource updating apparatus for updating resources used by said peripheral device or said computers being respectively connected, said resource managing program allowing a computer to execute the steps of

storing setting information indicating relation between each of said computers and resources set thereon,

searching, when resources of said peripheral device or one of said computers are updated, for the other computers concerning the updated resource on the basis of the setting information, and

notifying the searched computer that resources have been updated.

According to the present invention, there is provided an information processing system in which a server, and devices including pluralities of client terminals and peripheral devices are connected to a network, comprising:

storage holding means for storing and holding resource information concerning resources of the devices on the network;

first update means for updating a resource in accordance with a request from a client terminal;

second update means for updating the resource information in the storage holding means when the first update means updates the resource to a peripheral device;

comparison means for comparing resource information stored and held in the storage holding means with resource information which another client terminal has; and

third update means for updating the resource of the another client terminal on the basis of a comparison result of the comparison means.

According to the present invention, there is provided a method of controlling an information processing system in which a server, and devices including pluralities of client terminals and peripheral devices are connected to a network, comprising:

the storage holding step of storing and holding, in a predetermined storage medium, resource information concerning resources of the devices on the network;

the first update step of updating a resource in accordance with a request from a client terminal;

the second update step of updating the resource information in the storage medium when the resource to a peripheral device is updated in the first update step;

the comparison step of comparing resource information stored and held in the storage holding step with resource information which another client terminal has; and

the third update step of updating the resource of the another client terminal on the basis of a comparison result in the comparison step.

According to the present invention, there is provided a recording medium which stores a program code functioning as an information processing system in which a server, and devices including pluralities of client terminals and peripheral devices are connected to a network, wherein the program code includes:

a program code of the storage holding step of storing and holding, in a predetermined storage medium, resource information concerning resources of the devices on the network;

a program code of the first update step of updating a resource in accordance with a request from a client terminal;

a program code of the second update step of updating the resource information in the storage medium when the resource to a peripheral device is updated in the first update step;

a program code of the comparison step of comparing resource information stored and held in the storage holding step with resource information which another client terminal has; and

a program code of the third update step of updating the resource of the another client terminal on the basis of a comparison result in the comparison step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing a system according to the first embodiment of the present invention;

FIG. 2 is a view showing principal hardware modules of individual devices shown in FIG. 1;

FIG. 3 is a view showing the software configuration of a server 2;

FIG. 4 is a view showing the configuration of a peripheral device management program 305;

FIG. 5 is a view showing the software configuration of a manager PC 3;

FIG. 6 is a view showing the software configuration of client PCs 4 and 5;

FIG. 7 is a view showing the configuration of a downloader 502;

FIG. 8 is a flow chart showing processing performed by the downloader 502;

FIG. 9 is a view showing the configuration of a peripheral device information acquisition module 4031;

FIG. 10A is a flow chart showing the procedure of peripheral device information acquisition when an interrupt occurs;

FIG. 10B is a flow chart showing a procedure when no interrupt occurs;

FIG. 11 is a view showing the configuration of a main module of a management program 401;

FIG. 12 is a flow chart showing the processing of the software shown in FIG. 11;

FIG. 13 is a view showing the configuration of a GUI CGI program 402;

FIG. 14 is a view showing the configuration of a client module 603;

FIG. 15 is a view showing the flow of data when a font is downloaded to printers 6 and 7;

FIG. 16 is a view showing the flow of data when the client PCs 4 and 5 acquire a color calibration table;

FIG. 17 is a view showing the flow of data when address book data is acquired from a function composite type copying machine 8;

FIG. 18 is a view showing the flow of data when address book data on the client PC 4 is downloaded to function composite type copying machines 8 and 9;

FIG. 19 is a view showing the flow of data when the contents of a storage device of the function composite type copying machine 8 are backed up in the server 2;

FIG. 20 is a view showing the flow of data when the backed-up contents of the storage device of the printer 7 or of the function composite type copying machine 8 are restored;

FIG. 21 is a view showing the flow of data when the client PC 4 acquires software from the server 2;

FIG. 22 is a view showing the flow of data when the client PC 4 acquires a driver of a peripheral device, such as a printer driver, facsimile driver, or scanner driver, from the server 2;

FIG. 23 is a view showing a data structure when the server 2 sends data to the client PCs 4 and 5;

FIG. 24 is a view showing header information shown in FIG. 23 when the server 2 sends a font file to the client PC 4 or 5;

FIG. 25 is a view showing the header information shown in FIG. 23 when the server 2 sends an overlay form to the client PC 4 or 5;

FIG. 26 is a view showing the header information shown in FIG. 23 when the server 2 sends a color calibration table is sent to the client PC 4 or 5;

FIG. 27 is a view showing the header information shown in FIG. 23 when the server 2 sends, to the client PC 4 or 5, information used by a printer driver to overlay an image scanned by the scanner function of the function composite type copying machine 8 or 9;

FIG. 28 is a view showing the header information shown in FIG. 23 when software is sent to the client PC 4 or 5;

FIG. 29 is a view showing the header information shown in FIG. 23 when a driver is sent to the client PC 4 or 5;

FIG. 30 is a view showing a configuration according to the second embodiment of the present invention;

FIG. 31 is a view showing a floppy disk as an example of a storage medium for storing programs;

FIG. 32 is a view showing an example of program modules according to the present invention;

FIG. 33 is a view showing a process of loading a storage medium storing programs of the present invention into a server, manager personal computer, or user personal computer;

FIGS. 34A and 34B are views showing pieces of resource registration information in two formats;

FIG. 35 is a flow chart showing resource update information notification processing;

FIG. 36 is a view showing the configuration of the automatic resource update client module 603 of the client PC 4 or 5;

FIG. 37 is a flow chart showing processing performed by the server 2 in automatic resource update;

FIGS. 38A and 38B are views showing registered-resource information save data;

FIG. 39 is a flow chart showing processing of saving a resource;

FIG. 40 is a flow chart showing processing of saving a resource in accordance with user designations; and

FIG. 41 is a flow chart showing processing of restoring a saved resource.

### DETAILED DESCRIPTION OF THE PREFERRED EMBODIMENTS

Preferred embodiments of the present invention will now be described in detail in accordance with the accompanying drawings.

<First Embodiment>

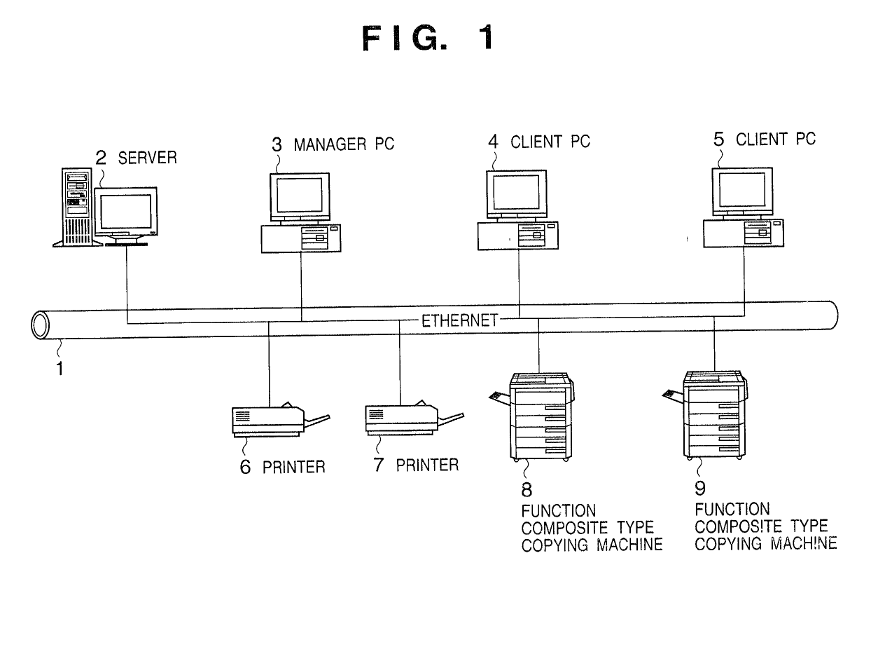

FIG. 1 is a view showing a system according to an embodiment of the present invention.

In FIG. 1, reference numeral 1 denotes a network, and Ethernet is used as this network 1. However, LocalTalk or the like can also be used. In this embodiment, “network” means one or a plurality of means (protocols) which implement information exchange by the combination of electrical signals, by using physical cables and the electrical signals propagating on these cables. Usually, “network” is a general term of these means.

A server 2 has various functions such as a file server function and Web server function, and plays a main role in this embodiment.

A manager personal computer (a personal computer will be simply referred to as a PC hereinafter) 3 gives designations to the server and peripheral devices.

Client PCs 4 and 5 are PCs connected to the network 1, which are used by general users. Note that the manager PC can also be used as a client PC.

Printers 6 and 7 are connected to the network 1 to receive printing instructions from the client PCs 4 and 5 and perform printing in accordance with the instructions.

Function composite type copying machines 8 and 9 can be used as a copying machine, printer, scanner, and facsimile apparatus by using one or the combination of a plurality of functions, e.g., a copying function, image scanner function, printer function, and facsimile function.

The operation of this system will be described below.

The server 2 periodically communicates with the printers 6 and 7 and the function composite type copying machines 8 and 9, and monitors the statuses of these devices and the settings of their software. The manager PC 3 changes the settings of these devices and changes their software or resources used by the software.

Pieces of designation information from the manager PC 3 are collected by the server 2, and the client PCs 4 and 5 receive the information from the server 2.

The server 2 has a communication function using http. The manager PC 3 and the client PCs 4 and 5 can acquire information of the server 2 by using a Web browser and can give designations to the server 2.

When receiving designation from the manager PC 3 or the client PC 4 or 5, the server 2 returns information which the server 2 has to the manager PC 3 or the client PC 4 or 5. Depending on the contents of the information, the server 2 acquires information from the printer 6 or 7 or the function composite type copying machine 8 or 9 and returns the information to the manager PC 3 or the client PC 4 or 5. Alternatively, the server 2 performs setting of the printers 6 and 7 and the function composite type copying machines 8 and 9.

The manager PC 3 has a downloader and can download software or resources used by the software to the printers 6 and 7 and the function composite type copying machines 8 and 9. Examples of the software are printing control firmware and network control firmware of these devices. In addition to these kinds of firmware, the function composite type copying machines 8 and 9 have, e.g., scanner control firmware, facsimile control firmware, copying machine firmware, panel operation firmware, image management software, and address management software.

Examples of the resources used by the software are fonts, EUDC (End User Defined Characters), overlay forms, calibration tables, address information used by the address management software, and facsimile numbers.

The client PCs 4 and 5 can acquire and hold software (e.g., drivers) for accessing and using the printers 6 and 7 and the function composite type copying machines 8 and 9, and resources (client PC resources) used by the software.

Examples of the software of the client PCs 4 and 5 are a printer driver for using a printer, a scanner driver for using a scanner, a facsimile driver for using a facsimile apparatus, copying machine utility software for controlling a copying machine, a network driver for using a network, a Web browser, and application software. Examples of the resources used by the software are client PC fonts corresponding to printer fonts, address information used by the facsimile driver, printing data used when color calibration is performed, and overlay images used in preview.

In this system, the set contents, software, and resources used by the software of the printer 6 can be reflected on the other devices, i.e., the printer 7 and the function composite type copying machines 8 and 9. Analogously, the set contents, software, and resources used by the software of the function composite type copying machine 8 can be reflected on the function composite type copying machine 9 and the printers 6 and 7.

If these device types have functional differences, only functions common to these device types are reflected. However, information of a convertible resource can be reflected after conversion. Furthermore, information concerning these device types on the client PC 4 can be reflected on the client PC 5. These processes are implemented by exchanging information via the server 2.

The set contents of the printers 6 and 7 and the function composite type copying machines 8 and 9 can be changed not only by designations from the manager PC 3 but also by designations from operation panels of these devices and from the client PC 4 or 5. If change information must be accurately transferred to the client PC 4 or 5, the printers 6 and 7 and the function composite type copying machines 8 and 9 are constantly inquired when the client PC 4 or 5 gives display designation or the like, and information at the inquiry timing can be returned to the client PC 4 or 5. If no strict accuracy is necessary, information held in the server 2 can be used.

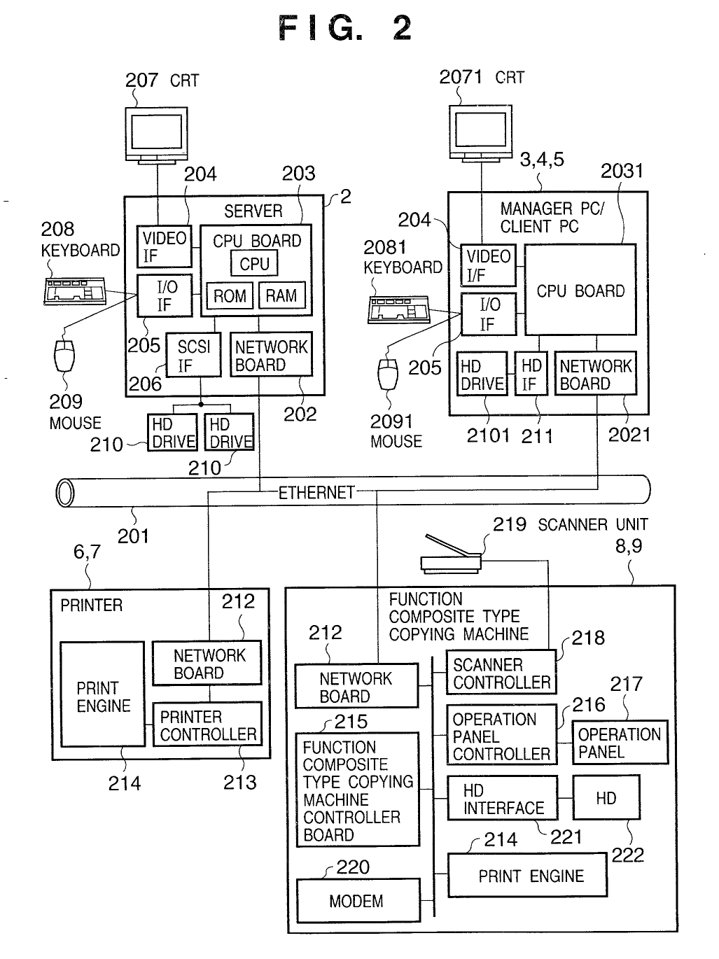

FIG. 2 is a view showing main hardware modules of the individual devices shown in FIG. 1.

In FIG. 2, a network line 201 is a physical line constructing a network between the devices. For example, a twisted pair cable, coaxial cable, or optical fiber can be used.

Hardware modules constituting the server 2 include a network board 202, CPU board 203, video interface 204, I/O interface 205, and SCSI interface 206, and also include a CRT 207, keyboard 208, mouse 209, and hard disk (HD) drive 210 connected to these boards and interfaces.

The server 2 has a plurality of HD drives 210 parallel-connected to each other, and this ensures high data transfer speed and high reliability between the HD drives 210 and the server 2.

The manager PC 3 and the client PCs 4 and 5 include a network board 2021, CPU board 2031, video interface 2041, I/O interface 2051, and HD interface 211, and also include a CRT 2071, keyboard 2081, mouse 2091, and hard disk drive 210 connected to these boards and interfaces. The manager PC 3 and the client PCs 4 and 5 have a basic structure common to that of the server 2 except for the structure of the hard disk drive 210 in this embodiment.

The hardware modules of the printers 6 and 7 include a network board 212 corresponding to the peripheral devices, a printer controller 213, and a print engine 214.

The hardware modules of the function composite type copying machines 8 and 9 include a network board 212 corresponding to the peripheral devices, a function composite type copying machine controller 215, a print engine 214, an operation panel controller 216, an operation panel 217, a scanner controller 218, a scanner unit 219, a modem 220, a hard disk IF 221, and a hard disk 222.

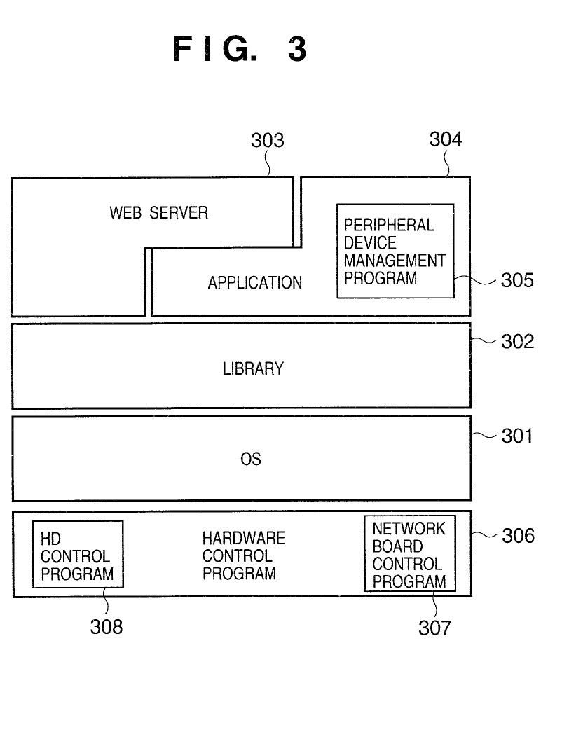

FIG. 3 is a view showing the software configuration of the server 2. In FIG. 3, reference numeral 301 denotes an OS (Operating System); 302, a library; 303, a Web server; 304, an application which includes a peripheral device management program 305; 306, a hardware control program which includes a network board control program 307 and a hard disk control program 308 as some of hardware control programs.

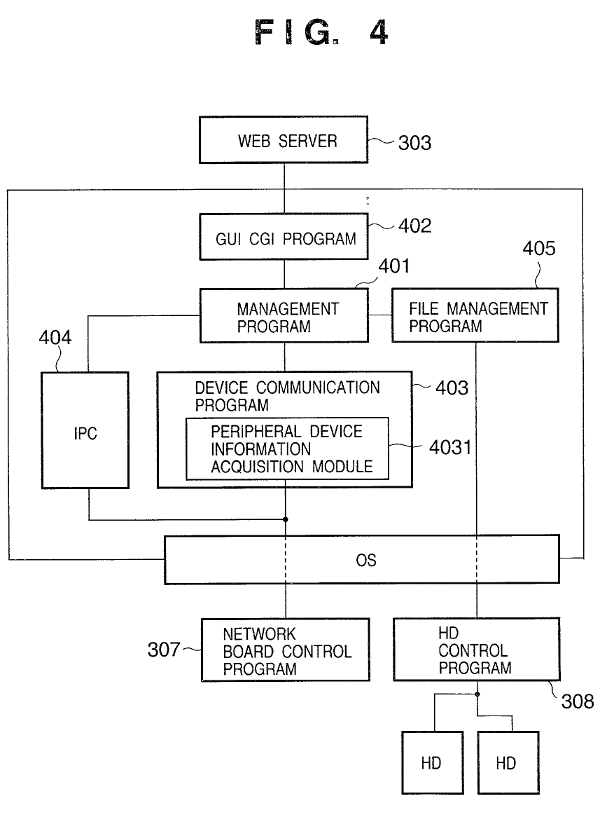

FIG. 4 is a view showing the configuration of the peripheral device management program 305.

This peripheral device management program 305 is implemented as one application on the server 2.

Reference numeral 401 denotes a management program, which serves as a main portion of the peripheral device management program 305 to control the peripheral device management program 305. A GUI CGI program 402 transfers data expressed in an html format to the Web server 303. The Web server 303 sends, in an http format, the data from the GUI CGI program 402 to the manager PC 3 or the client PCs 4 and 5, and transfers designations from the manager PC 3 or the client PCs 4 and 5 to the management program 401.

A device communication program 403 includes a peripheral device information acquisition module 4031. The device communication program 403 performs communications between the peripheral devices and the server 2 by using the network board control program 307 to acquire information and the like from a device, set a peripheral device, and download software and resources used by the software.

An IPC 404 is a program for performing inter-process communications. This IPC 404 communicates with other PCs, particularly the manager PC 3 by using the network board control program 307. A file management program 405 implements a file server function by using the HD control program 308.

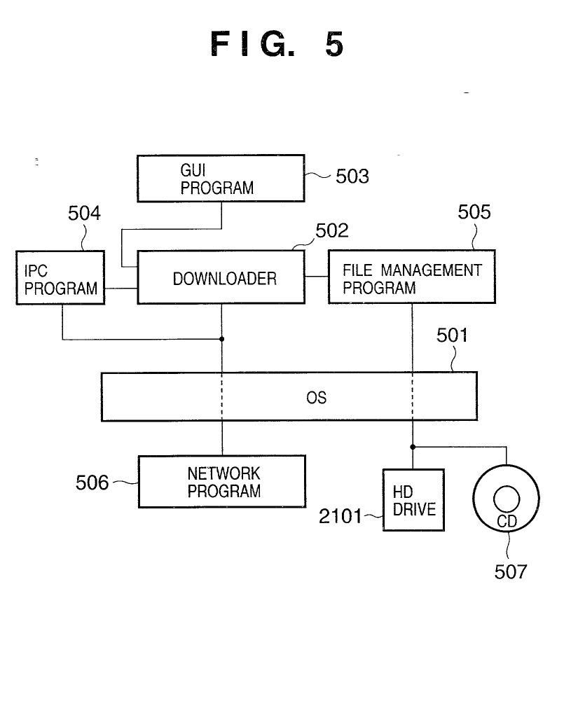

FIG. 5 is a view showing the software configuration of the manager PC 3.

An OS 501 performs general processing of the manager PC. A downloader 502 downloads software and resources used by the software to a peripheral device.

A GUI program 503 has a user IF module for displaying information and transferring designations from a user to the downloader, and implements a user interface function. An IPC program 504 communicates with the IPC 404 of the server. A file management program 505 is usually installed as a part of the OS 501. This file management program 505 performs file management when the contents (file) of the HD drive 2101 are read out or a CD-ROM drive (not shown) is added in the manager PC 3 to read out the contents (file) of a CD-ROM 507, and when the read-out contents (files) are downloaded to a peripheral device via the downloader 502.

A network program 506 is commonly installed as a part of the OS 501. This network program 506 performs network communications when the file read out from the HD drive 2101 or CD-ROM is downloaded to a peripheral device via the downloader 502.

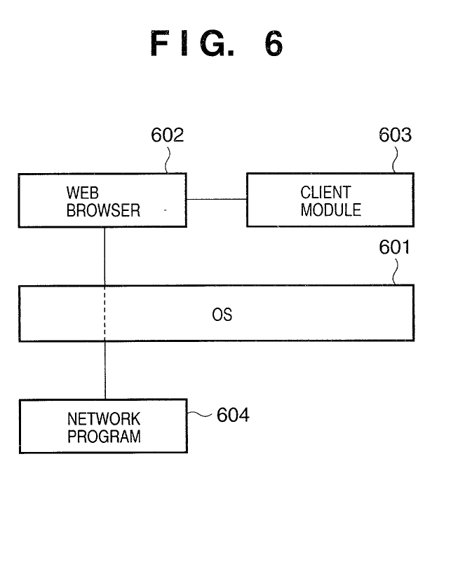

FIG. 6 is a view showing the software configuration of the client PCs 4 and 5.

An OS 601 performs general processing of the client PC. A Web browser 602 receives data expressed in an html format from the Web server 303 of the server 2 and displays the data on the screen, and also transfers designations from a user to the server 2 by using http.

A client module 603 processes some of data which are received by the Web browser 602 and cannot be processed by the Web browser 602. Data which cannot be processed by the Web browser 602 are, e.g., software such as printer drivers of the client PCs 4 and 5 and resources such as fonts of the client PCs 4 and 5. These data must be respectively installed in the client PCs 4 and 5 by predetermined methods. A network program 604 is usually installed as a part of the OS 601 and communicates with the Web server 301 by using http.

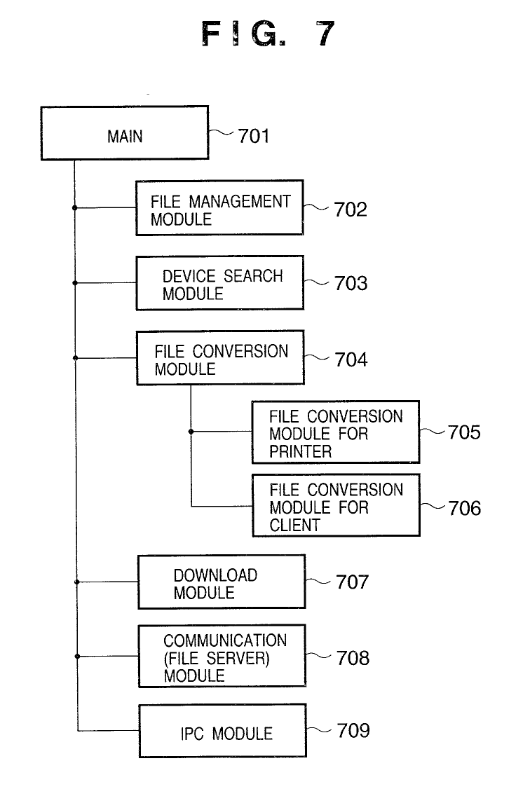

FIG. 7 is a view showing the configuration of the downloader 502.

A main module 701 calls each module and processes parameters (to be described later). A file management module 702 opens or reads a file to be downloaded by using the file management program 505. A device search module 703 searches for a downloadable peripheral device and acquires, e.g., a protocol capable of communication and the address of the device.

A file conversion module 704 converts resources used by software if the format of a resource for the printers 6 and 7 is different from the format of a resource for the client PCs 4 and 5. This file conversion module 704 contains a file conversion module 705 for the printers and a file conversion module 706 for the client PCs 4 and 5. For example, resource formats are different when the printer 6 or 7 uses fonts expressed by cubic curves whereas the client PCs 4 or 5 uses fonts expressed by quadratic curves, or when the printers 6 and 7 have an overlay image expression format different from that of the client PCs 4 and 5.

A download module 707 performs download by using the network program 506. A communication module 708 communicates with the server 2 and sends resources for the client PCs 4 and 5 to the server 2. An IPC module 709 performs inter-process communications. That is, this IPC module 709 implements inter-process communications by using the IPC program 504.

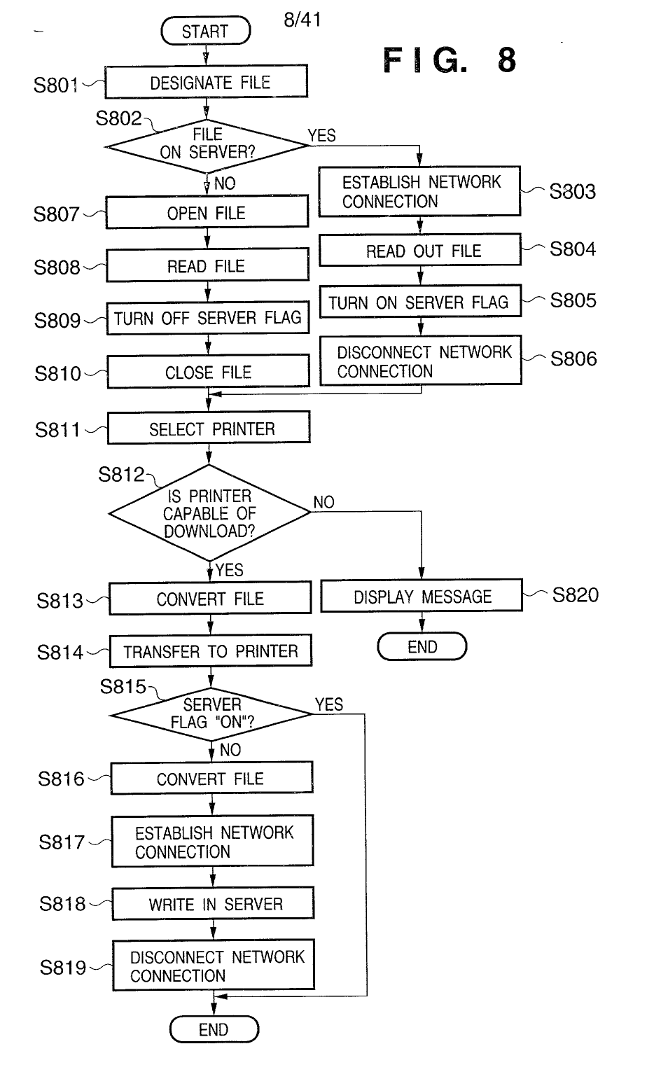

FIG. 8 is a flow chart showing the processing performed by the downloader 502.

Although download of a font will be described below, other software and resources used by the software are similarly processed. Assume that the downloader 502 is always communicating with the server 2 and capable of acquiring file names and device names but, in order to acquire a file managed in the file server of the server 2, the downloader 502 must read out the file by separately establishing a connection.

In step S801, a font file to be downloaded is designated. That is, the user of the downloader 502 designates a font file by inputting the file name.

In step S802, whether the font file designated in step S801 is on the server 2 is checked. If the font file is on the server 2, the flow advances to step S803. If the font file is not on the server 2, the flow advances to step S807.

In step S803, a connection to the server 2 via the network is established. In step S804, the font file on the server 2 that is designated in step S801 is read out. In step S805, a server flag is turned on.

In step S806, the connection to the server 2 via the network is disconnected. In step S807, the font file on the manager PC 3 is opened. In step 808, the file opened in step S807 is read. In step S809, the server flag is turned off. In step S810, the font file opened in step S807 is closed. That is, the file to be downloaded is loaded into the downloader 502 in step S806 or S810.

In step S811, a printer to which the font file loaded into the downloader 502 in step S810 is to be downloaded is selected. In step S812, whether the printer selected in step S811 is capable of download is checked. This determination is done on the basis of the type of the printer and a built-in storage device (e.g., a RAM, flash memory, or hard disk) of the printer. If the printer type allows download and a storage device capable of download exists in the printer, it is determined that the printer is capable of download.

If it is determined in step S812 that the printer is capable of download, the flow advances to step S813; if not, the flow advances to step S820. In step S813, the font file is converted into a form which can be downloaded to the printer. However, if the font file is already in a downloadable form, nothing is performed.

In step S814, the font file in the downloadable form is transferred to the printer determined to be capable of download. In step S815, whether the server flag is ON is checked. If the flag is ON (a downloaded font file is a font file on the server 2), it is determined that a client file already exists in the server 2, so the processing is completed. If the server flag is OFF (a downloaded font file is not a font file on the server 2), the flow advances to step S816.

In step S816, the downloaded font file is converted into a form usable by the client PC. However, if the font file is already in a form usable by the client PC, nothing is performed.

In step S817, a connection to the server 2 via the network is established. In step S818, the font file for the client PC is written in the server 2. In step S819, the connection is disconnected, a network closing process is performed, and the processing is completed.

In step S820, a message indicating that the file cannot be downloaded to the printer is displayed, and the processing is terminated.

By the above processing, the client PC font file corresponding to the font file downloaded to the selected printer necessarily exists in the server 2. Font file conversion is performed by converting the font file format itself or by adding header information and the like. For example, to download a TrueType (registered trademark) font file into a printer containing a TrueType rasterizer, the font file must be downloaded by adding header information for the printer. Therefore, the file conversion process adds this header information for the printer and the like. When this font is to be used on a Mac OS, information called a FOND resource is added as additional information.

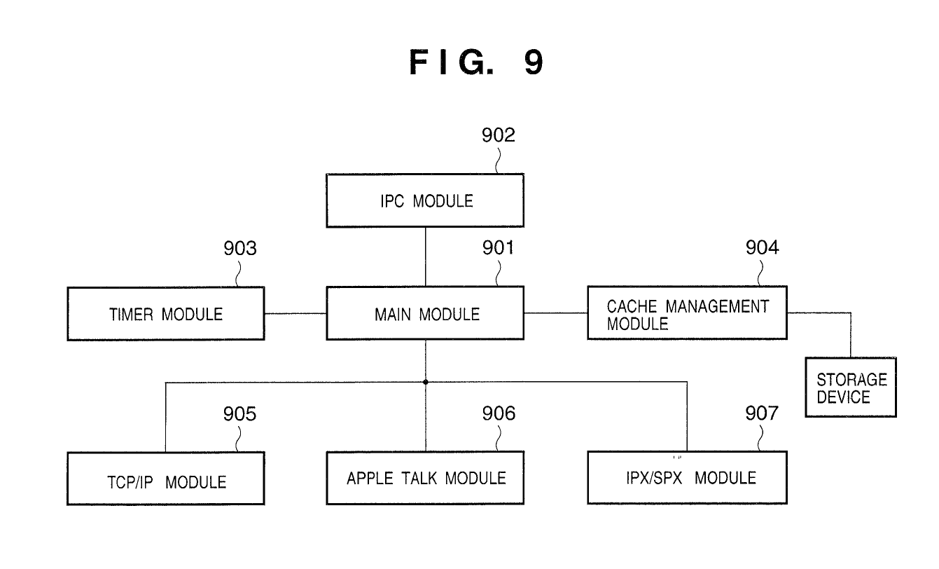

FIG. 9 is a view showing the configuration of the peripheral device information acquisition module 4031 included in the device communication program 403.

A main module 901 of this peripheral device information acquisition module 4031 performs control of the overall peripheral device information acquisition module 4031, communication, management, processing when an interrupt occurs, and exchange of download data with respect to a peripheral device. An IPC module 902 exchanges information with another module by inter-process communication.

A timer module 903 generates interrupts at predetermined intervals. The main module 901 so operates as to acquire information of a peripheral device at the timing of each interrupt. A cache management module 904 temporarily stores peripheral device information acquired by the main module 901 in accordance with an interrupt generated by the timer module 903. When instructed to send peripheral device information by the IPC module 902, the cache management module 904 sends the information stored in the cache management module 904 to another module via the IPC module 902.

A TCP/IP module 905 exchanges data with peripheral devices capable of acquiring information and downloading data by TCP/IP. An Apple Talk module 906 exchanges data with peripheral devices capable of acquiring information and downloading data by Apple Talk. An IPX/SPX module 907 exchanges data with peripheral devices capable of acquiring information and downloading data by IPX/SPX.

Protocols other than TCP/IP, AppleTalk, and IPX/SP can be handled by executing processes corresponding to protocols other than TCP/IP, AppleTalk, and IPX/SP.

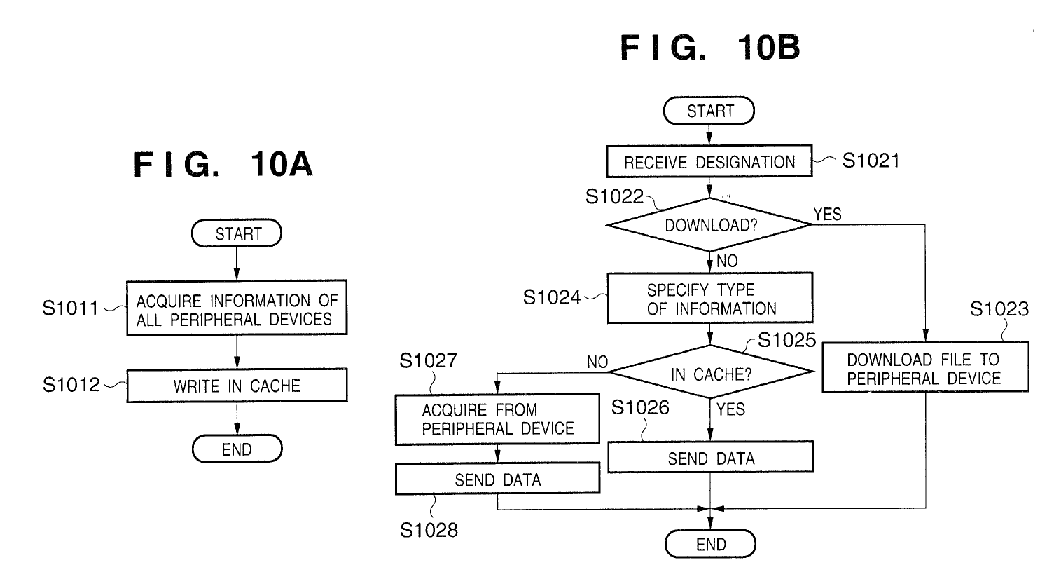

FIG. 10A is a flow chart showing the procedure of peripheral device information acquisition performed by the peripheral device information acquisition module 4031 when an interrupt occurs. When an interrupt occurs, this processing is executed.

In step S1011, information is acquired from all peripheral devices as objects. The acquired information contains the version of software, the version of a resource used by the software, the file size, the date, and the typeface name if the file is a font, i.e., this information is for checking whether the software and the resource used by the software are not changed. In step S1012, the acquired information is written in the cache of the cache management module 904.

FIG. 10B is a flow chart showing the procedure of processing performed by the peripheral device information acquisition module 4031 when no interrupt occurs (normal processing).

In this normal processing, peripheral device information is acquired or downloaded in accordance with user designations received by a module having a user IF. In step S1021, designations from the user IF module are received via the IPC module 902. The contents received by the designations are contents to be processed, data to be downloaded, the address of a peripheral device, and the like.

In step S1022, whether the designations from the user IF module received in step S1021 can be downloaded is checked. If YES in step S1022, the flow advances to step S1023. If NO in step S1022, the flow advances to step S1024. In step S1023, transmitted data is downloaded to a designated peripheral device, and the processing is completed.

In step S1024, the type of necessary information is specified. The type of information is, e.g., the typeface name, form size, or software version. In step S1025, whether the necessary information exists in the cache of the cache module 904 is checked. If YES in step S1025, the flow advances to step S1026. If NO in step S1025, the flow advances to step S1027.

In step S1026, the necessary information is transmitted from the cache of the cache module 904 via the IPC module 902. In step S1027, the peripheral device information is acquired from the peripheral device. In step S1028, the acquired peripheral device information is transmitted via the IPC module 902, and the processing is completed.

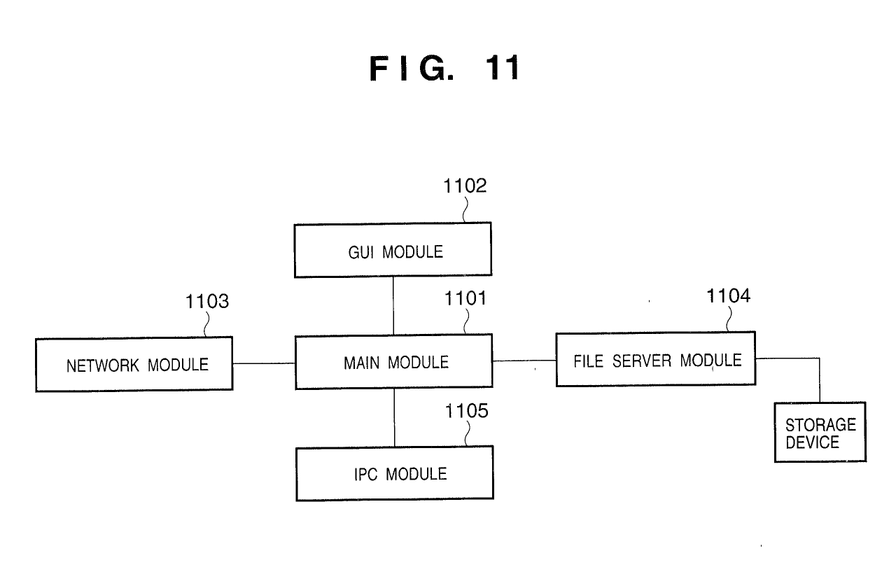

FIG. 11 is a view showing the configuration of a main module of the management program 401.

A main module 1101 performs operation management of the overall management program 401 and distribution of processing. A GUI module 1102 performs information exchange, e.g., sends information to be displayed to the GUI CGI program 402 and receives processing and data from the GUI CGI program. A network module 1103 inputs and outputs files and information via the network 1. A file server module 1104 performs read, write and management of files.

An IPC module 1105 exchanges data and information with the IPC module 902 by inter-process communication. That is, this program can access peripheral devices and the GUI CGI program 402, or the network 1 and the file server and controls the operation of the overall peripheral device management program 305.

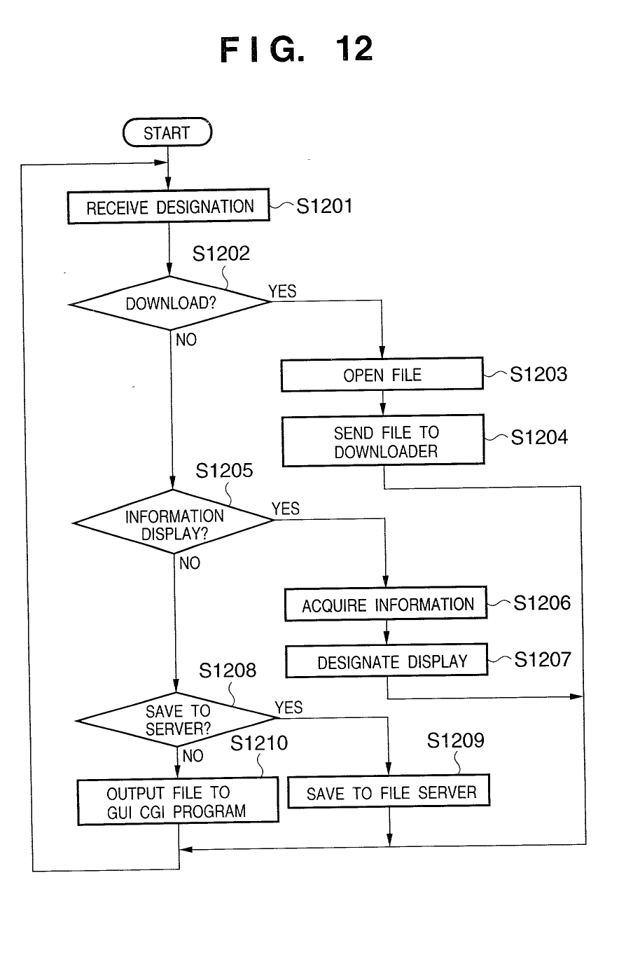

FIG. 12 is a flow chart showing the processing performed by the software shown in FIG. 11.

In step S1201, the same designation as in step S1021 is received from the IPC module 1105. In step S1202, whether the designation is download is checked. If the designation is download, the flow advances to step S1203; if not, the flow advances to step S1205.

In step S1203, the file on the file server is opened. In step S1204, the file is sent to the downloader 502 via the network module 1103. After that, the flow returns to step S1201 to perform the next processing. In step S1205, whether the designation is information display is checked. If the designation is information display, the flow advances to step S1206; if not, the flow advances to step S1208.

In step S1206, information exchange is performed between the IPC module 902 and the IPC module 1105 to acquire the information of the peripheral device. In step S1207, the information to be displayed is output to the GUI CGI program 402 via the GUI module 1102. After that, the flow returns to step S1201 to perform the next processing.

In step S1208, whether the designation is save of a file to the server 2 is checked. If the designation is save of a file to the server 2, the flow advances to step S1209; if not, the flow advances to step S1210. Save of a file to the server 2 is performed by designation from the downloader 502, and the file is transmitted via the network 1.

In step S1209, the file is saved in the file server. After that, the flow returns to step S1201 to perform the next processing. In step S1210, the file is output via the GUI CGI program 402. This is to output a client PC resource or the like. That is, the GUI CGI program 402 outputs the file or the like to the client PC 4 or 5 by using http which is a protocol by which the GUI CGI program 402 communicates with the client PC 4 or 5. After that, the flow return to step S1201 to perform the next processing. By a series of these processes, information and data in this module are transmitted and received.

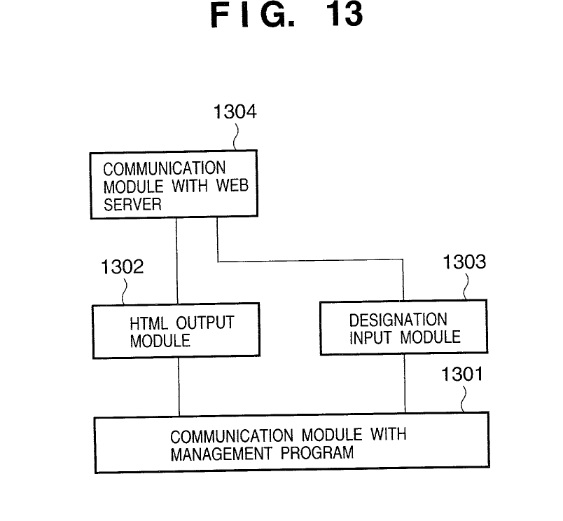

FIG. 13 is a view showing the configuration of the GUI CGI program 402.

A communication module 1301 communicates with the management program 401 to receive designations, files, and information from the management program 401 and transfers them to an html output module 1302. This communication module 1301 also transfers designations and files received from a designation input module 1303 to the management program 401.

The html output module 1302 forms a GUI frame file based on html standards using information and designations received from the management program 401, and transfers the file to a communication module 1304 which communicates with the Web server 303. The designation input module 1303 receives designations or archived or encoded files from the Web server 303, and transfers the designations as instructions to the management program 401. The designation input module 1303 transfers, to the management program 401, the archived files after separating them and the encoded files after decoding them. The communication module 1304 which communicates with the Web server 303 sends html information to the Web server 303 and transfers designations from the Web server 303 to the designation input module 1303.

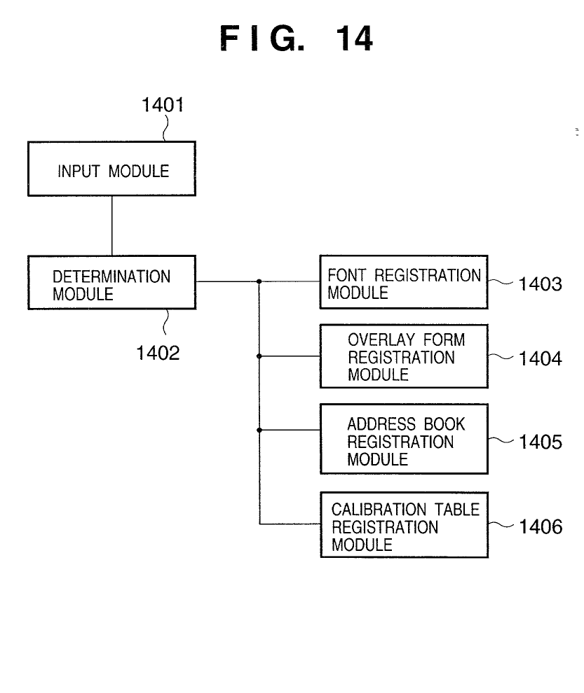

FIG. 14 is a view showing the configuration of the client module 603. This module is installed in the client PCs 4 and 5 and processes files received by the Web browser 602.

An input module 1401 receives data from the Web browser 602. The received data is usually archived data containing management information and a file entity. A determination module 1402 separates the file received from the Web browser 602 into the management information and the file entity, and determines the type of the file on the basis of the management information.

The management information contains, e.g., the type of file, the file name, and the file size. If the file type represents a font, the determination module 1402 calls a font registration module 1403. If the file type is an overlay form, the determination module 1402 calls an overlay form registration module 1404. If the file type represents an address book, the determination module 1402 calls an address book registration module 1405. If the file type represents a color calibration table, the determination module 1402 calls a color calibration table registration module 1406.

The font registration module 1403 registers a received font in the client PC 4 or 5. The overlay form registration module 1404 registers a received overlay form in an overlay form processing application. When no overlay processing application is installed, this overlay form registration module 1404 does not perform any processing.

The address book registration module 1405 registers a received address book after converting it into the format of a registration destination, e.g., e-mail management software or a FAX driver. The color calibration table registration module 1406 registers a received file in a printer driver for performing image processing.

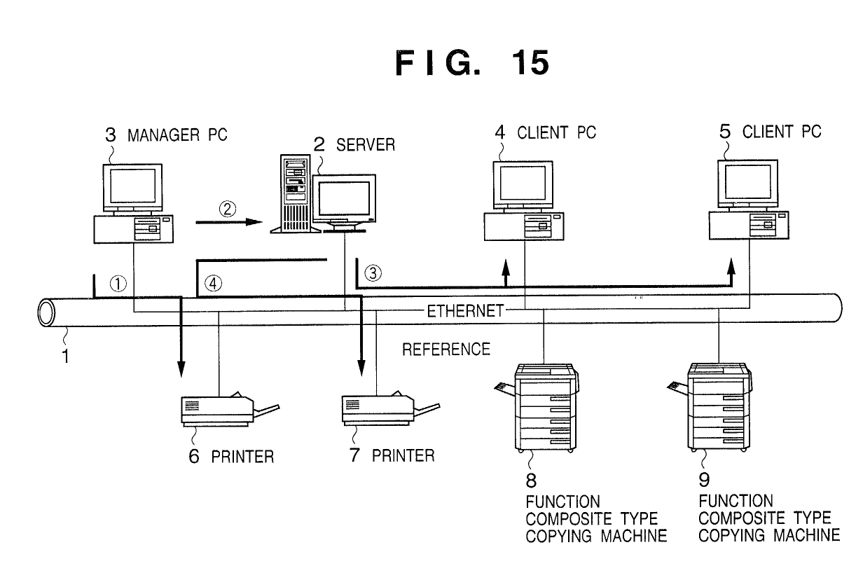

FIG. 15 is a view showing the flow of data when a font is downloaded to the printers 6 and 7. In FIG. 15, a font loaded from a CD-ROM or the HD drive 2101 to the manager PC 3 by the manager is downloaded to the printer 6 (\mathring{1}). The font is then registered in the server 2 (\mathring{2}). The client PCs 4 and 5 load the client PC font file from the server 2 by using the Web browser 602 and register the file in the system by the client module 603 (\mathring{3}). To download the font to the other printer, the manager PC 3 loads the font registered in the server 2 and downloads the font to the printer 7 (\mathring{4}). This data flow is the same when an overlay form is to be registered.

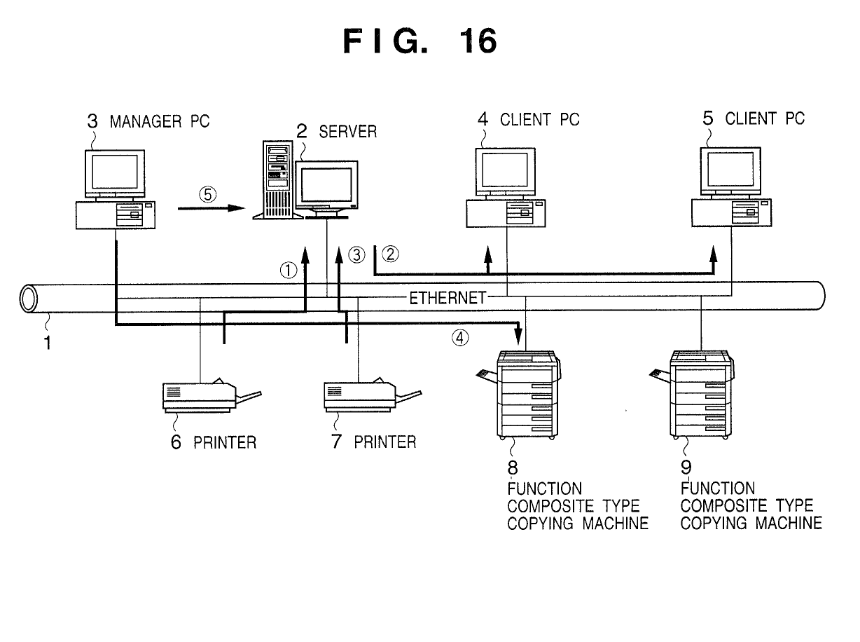

FIG. 16 is a view showing the flow of data when the client PCs 4 and 5 acquire a color calibration table.

A color calibration table generated in the printer 6 is transmitted to the server 2 (\mathring{1}). The client PCs 4 and 5 receive this color calibration table of the printer 6 by using the Web browser 602 and register the table in the printer drivers which the client PCs have (\mathring{2}).

A color calibration table generated in the printer 7 is transmitted to the server 2 (\mathring{3}). If the client PCs 4 and 5 are to receive this color calibration table of the printer 7, processing is the same as in \mathring{2}. \mathring{1} and \mathring{3} are periodically carried out by interrupt processing. \mathring{4} indicates the flow of data when a color calibration table is to be downloaded from the manager PC 3. That is, when a calibration table is formed by the manager PC 3 by using colorimetry software or the like, this calibration table is downloaded from the manager PC 3. The same data as the downloaded data (calibration table generated by the manager PC 3) is directly transmitted from the manager PC 3 to the server 2.

The data is transferred from the server 2 to the client PC 4 or 5 in the same manner as the method of transmitting a color calibration table generated in a printer to the client PC 4 or 5. When image data input by the scanner function of the function composite type copying machine 8 or 9 is to be transferred to a printer driver so as to be used as an overlay form, the data is also transferred in the same manner.

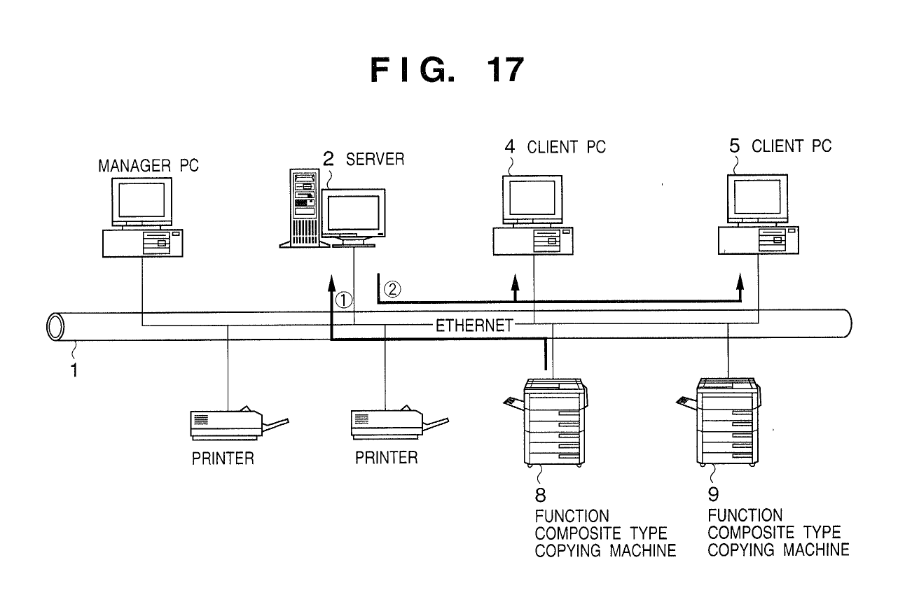

FIG. 17 is a view showing the flow of data when address book data is acquired from the function composite type copying machine 8.

Address book data in the function composite type copying machine 8 is sent to the server 2 (\mathring{1}). The client PC 4 or 5 receives the data from the server 2, and the client module 603 adds the data to or overwrites the data on address book data in the client PC 4 or 5 (\mathring{2}).

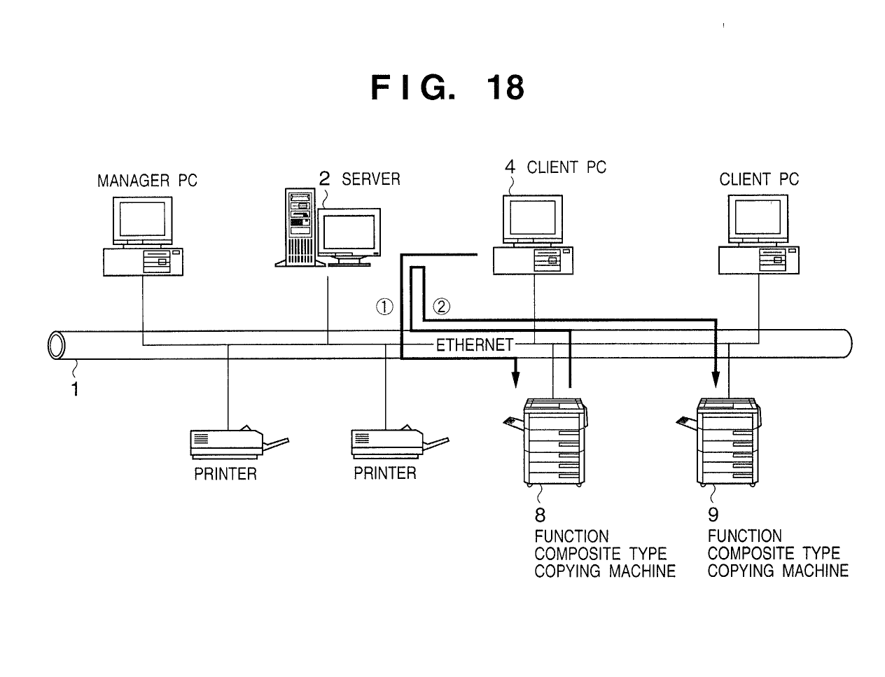

FIG. 18 is a view showing the flow of data when address book data on the client PC 4 is downloaded to the function composite type copying machines 8 and 9.

Address book data sent to the server 2 by using the Web browser 602 is directly written in the function composite type copying machine 8 (\mathring{1}). \mathring{2} indicates the flow of data when the address book of this function composite type copying machine 8 is to be copied in a function composite type copying machine. The data of the function composite type copying machine 8 is once transmitted to the server 2 and written in the function composite type copying machine 9.

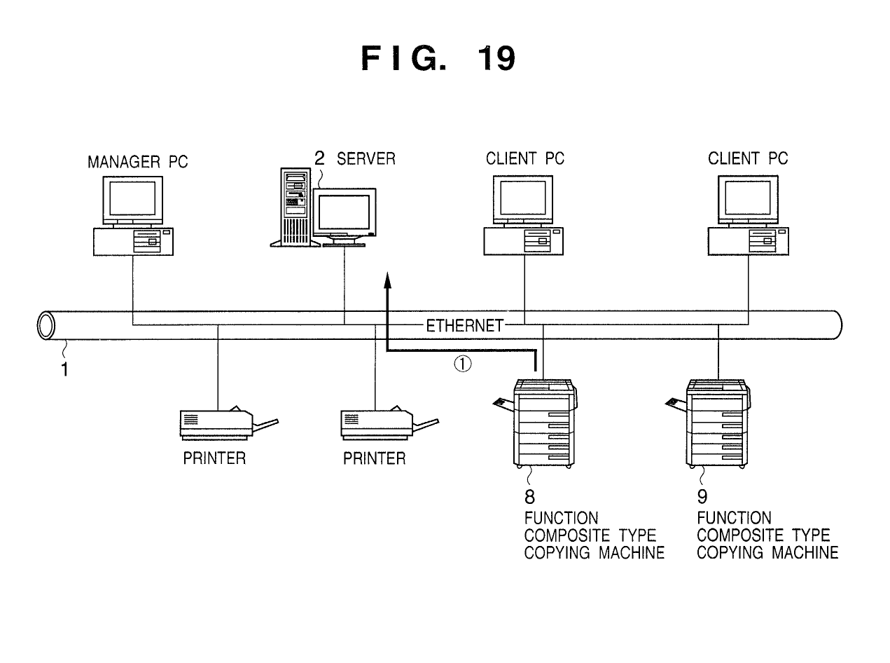

FIG. 19 is a view showing the flow of data when the contents of the storage device of the function composite type copying machine 8 are backed up in the server 2. Although this processing is normally designated and activated by the Web browser 602, it can also be designated and activated from the operation panel of the function composite type copying machine 8.

The contents of the storage device of the function composite type copying machine 8 are sent to the server 2 and stored in the internal file server of the server 2 (\mathring{1}). Note that the flow of data shown in FIG. 19 is the same for a printer other than the function composite type copying machine.

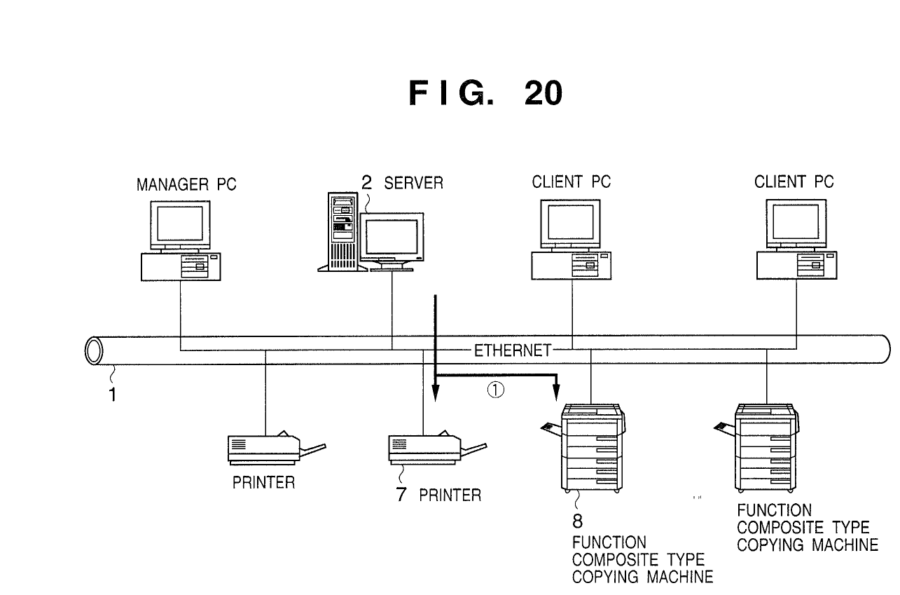

FIG. 20 is a view showing the flow of data when the backed-up contents of the storage device of the printer 7 or of the function composite type copying machine 8 are restored. This processing is usually designated and activated by the Web browser 602, but it can also be designated and activated from the operation panel of the function composite type copying machine 8.

The data backed up in the internal file server of the server 2 is sent to the storage device of the printer 7 or of the function composite type copying machine 8 as the backup source (\mathring{1}).

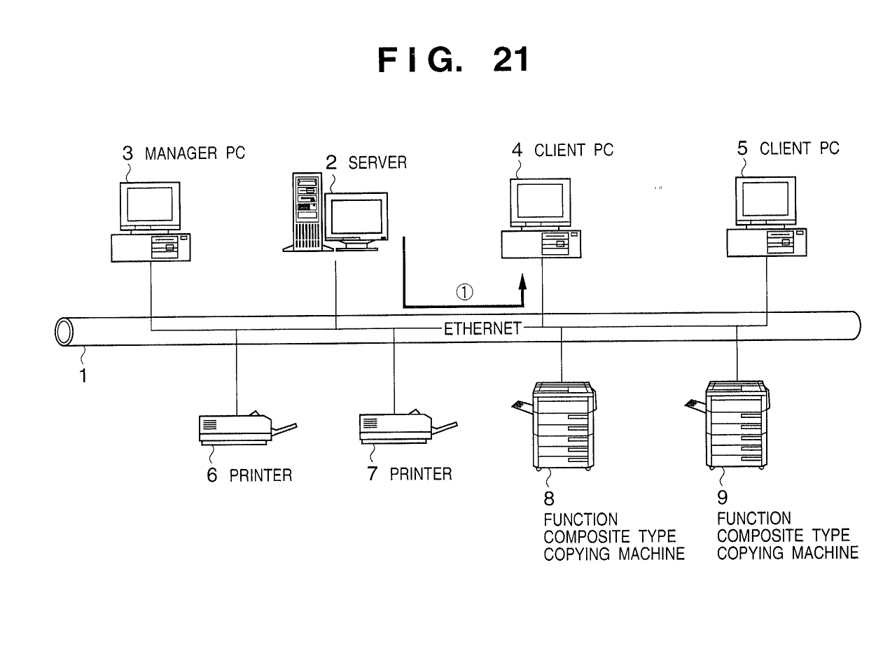

FIG. 21 shows the flow of data when the client PC 4 acquires software from the server 2. Data is acquired from the server 2, and the client module 603 decodes and installs the data (\mathring{1}).

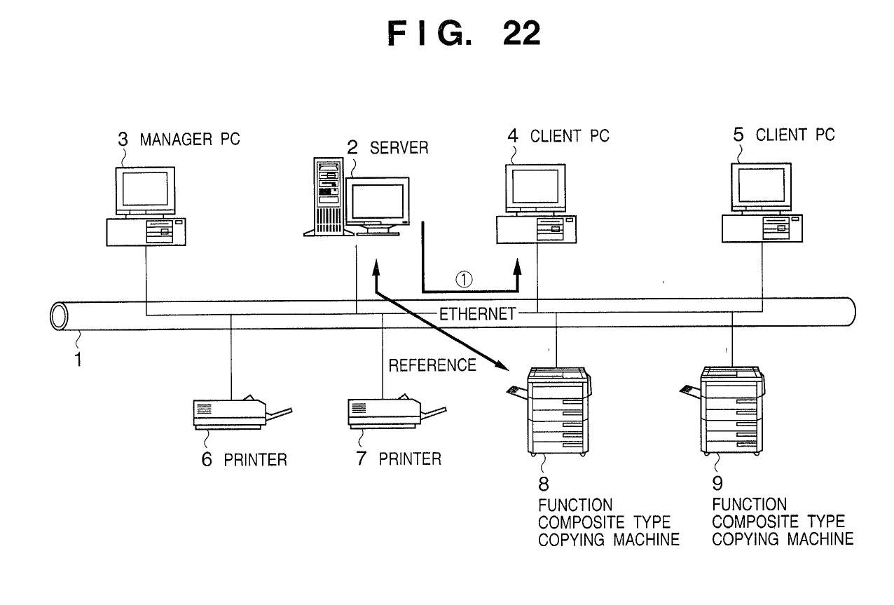

FIG. 22 shows the flow of data when the client PC 4 acquires a driver of a peripheral device, such as a printer driver, facsimile driver, or scanner driver, from the server 2.

Data is acquired from the server 2 (\mathring{1}). When sending this data, however, the server 2 refers to a peripheral device of interest (function composite type copying machine 8 in FIG. 22) to obtain matching with this peripheral device. That is, the server 2 sends the network address, device type, functions, and the like together with the device driver to the client PC 4. On the basis of these pieces of information sent from the server 2, the client module 603 installs the driver.

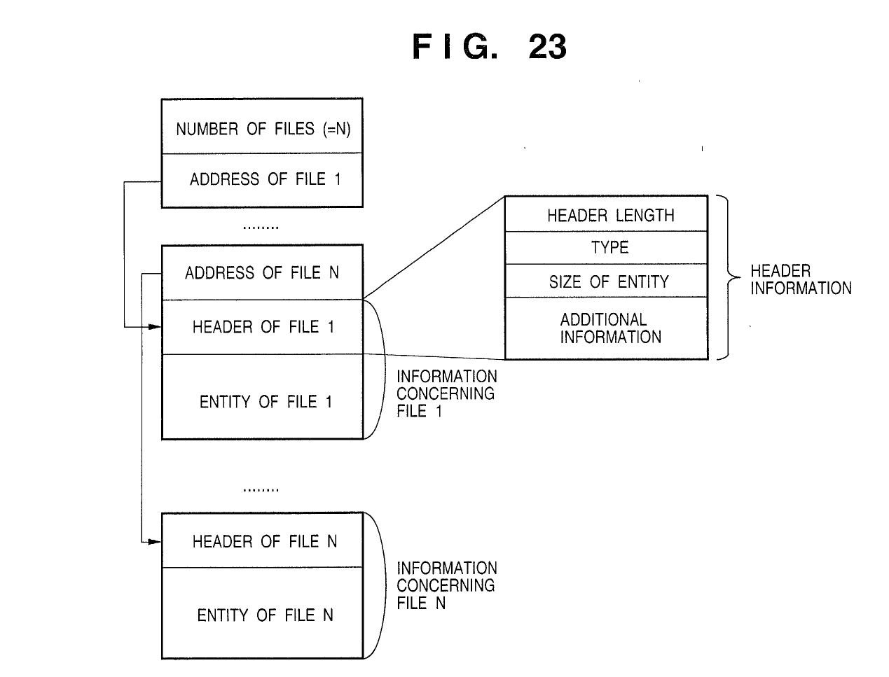

FIG. 23 is a view showing a data structure when the server 2 sends data to the client PC 4 or 5. As shown in FIG. 23, the number N of files held as an archive inside the data is set in the start position. The array of N addresses follows, and a file entity held together with a header exists in a position indicated by each address. The header contains the header length, the type of the file, and the size of the entity as header information. If additional information is present, it follows the header. That is, the file entity exists after the header length from the start position of the header.

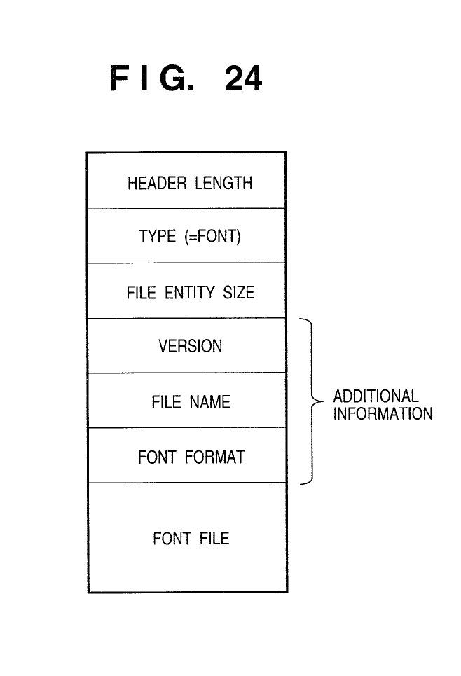

FIG. 24 is a view showing the header information shown in FIG. 23 when the server 2 sends a font file to the client PC 4 or 5. As shown in FIG. 24, the version, file name, and font type are added as additional information.

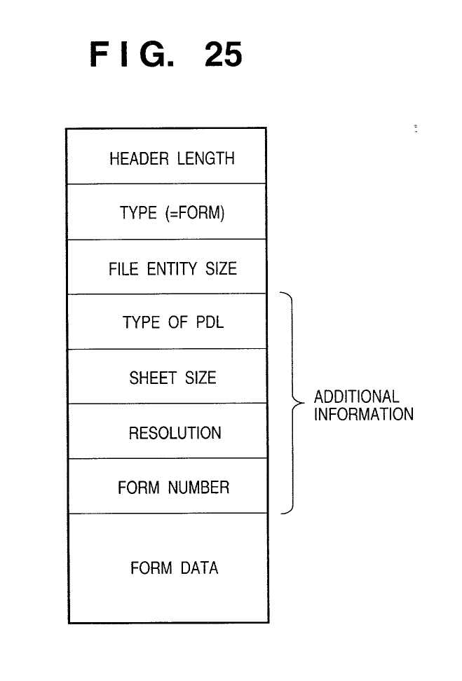

FIG. 25 is a view showing the header information shown in FIG. 23 when the server 2 sends an overlay form to the client PC 4 or 5. As shown in FIG. 25, the type of PDL, sheet size, resolution, and form number are added as additional information.

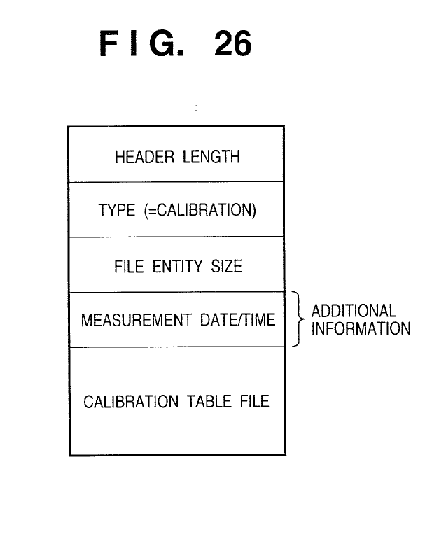

FIG. 26 is a view showing the header information shown in FIG. 23 when the server 2 sends a color calibration table to the client PC 4 or 5. As shown in FIG. 26, the date and time at which color calibration table information is measured are added as additional information.

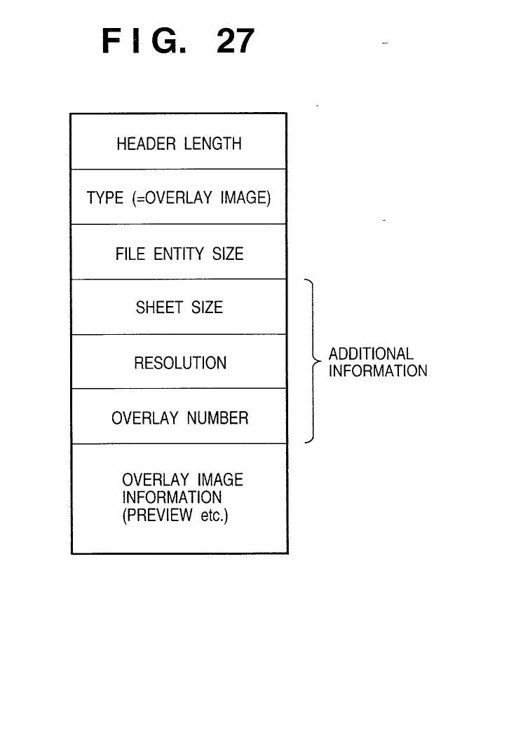

FIG. 27 is a view showing the header information shown in FIG. 23 when the server 2 sends, to the client PC 4 or 5, information which a printer driver uses to overlay an image scanned by the scanner function of the function composite type copying machine 8 or 9. As shown in FIG. 27, the sheet size, resolution, and overlay number are added as additional information.

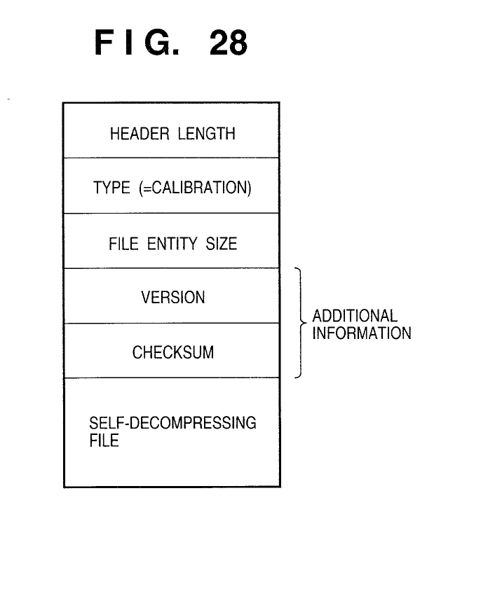

FIG. 28 is a view showing the header information shown in FIG. 23 when software is sent to the client PC 4 or 5. As shown in FIG. 28, the version of the software and the checksum of the file are added as additional information. Also, the file entity of the software is a self-decompressing installer. The client module 603 activates the downloaded self-decompressing installer.

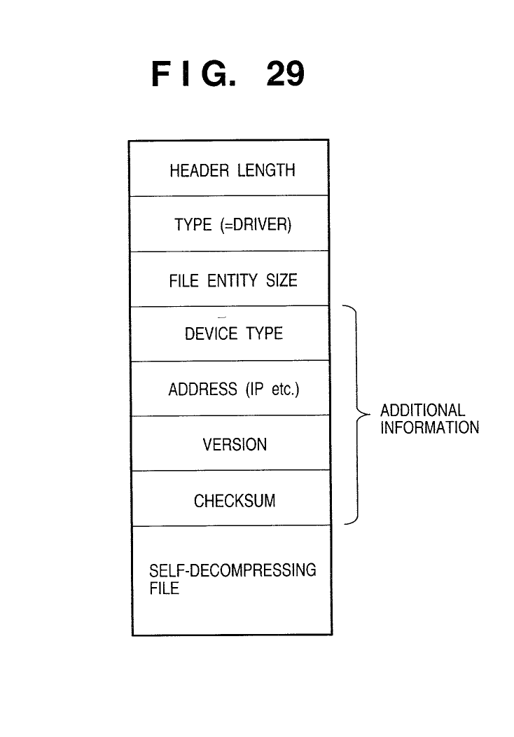

FIG. 29 is a view showing the header information shown in FIG. 23 when a driver is sent to the client PC 4 or 5. As shown in FIG. 29, the device type of the peripheral device, the address (e.g., the IP address in the case of TCP/IP connection) for accessing the peripheral device, the version of the driver, and the checksum of the file are added as additional information. Also, the file entity of the driver is a self-decompressing installer. The client module 603 activates the downloaded self-decompressing installer by using the device type and the address as arguments.

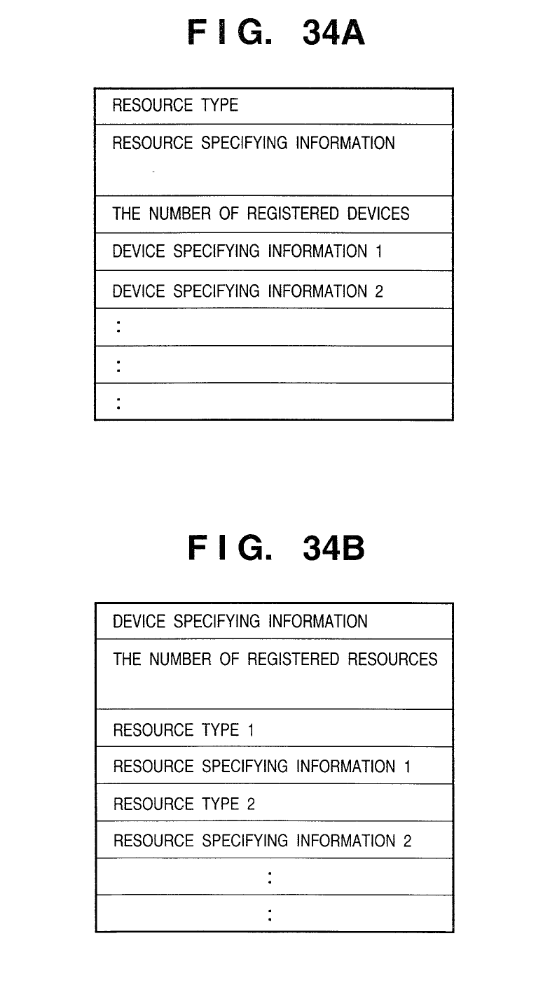

FIGS. 34A and 34B are views showing pieces of management information (setting information) for resources registered in devices such as the printers 6 and 7, the function composite type copying machines 8 and 9, and the client PCs 4 and 5. This management information is held in the server 2. Unitary resource management is implemented by centralizing the resources.

FIG. 34A shows an example of a format which associates pieces of information of devices as registration destinations for each resource. FIG. 34B shows an example of a format which associates registered resources for each device.

In FIGS. 34A and 34B, the resource type is a code of a font, an external character, a form, or the like. When the resource type is a font, resource specifying information includes information for specifying the font, such as a typeface, weight, or style, and information for specifying the version of the resource. Device specifying information includes information representing any device of the printers 6 and 7, the function composite type copying machines 8 and 9, and the client PCs 4 and 5, and address information on a network.

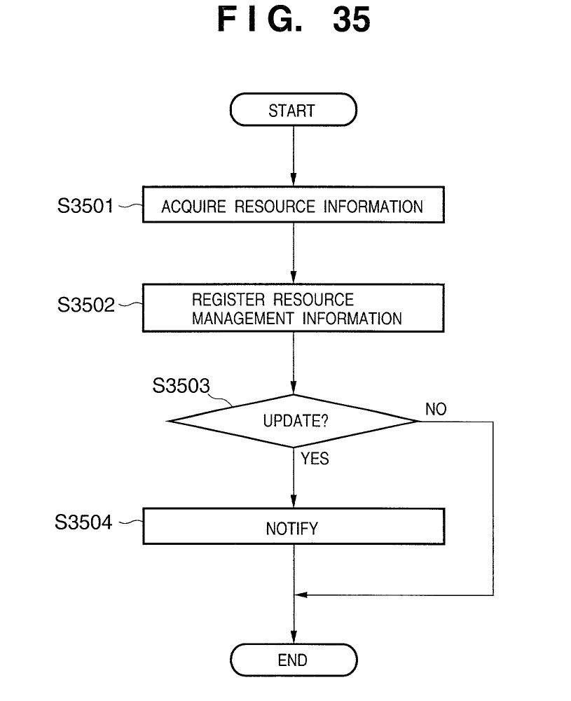

FIG. 35 is a flow chart showing processing performed when a resource is updated by the manager PC 3, and a device associated with the updated resource is notified of the update. Update of the resource includes additional setting of a new resource, partial replacement of the resource, or partial or entire deletion of the resource.

In step S3501, information about resource update executed with respect to a device via the downloader 502 is acquired by the communication module 708.

In step S3502, the acquired information is registered in management information. For example, in management information of FIG. 34A, if resource specifying information has the same data for a newly added resource or a replaced resource, the number of registered devices is incremented by one, and device specifying information is added. When a resource is to be deleted, device specifying information associated with the resource specifying information is deleted from management information, and the number of registered devices is decremented by one. When a new resource is to be added, resource specifying information is newly added, the number of registered devices is incremented by one, and device specifying information is added. This registration processing is the same for management information in FIG. 34B, and management information is updated in accordance with addition, replacement, and deletion.

In step S3503, a device associated with the updated resource is searched, i.e., the presence/absence of a device on which update of the resource should be reflected is checked. That is, the device is a device which downloads an identical resource in the case of replacement, and is a device requiring the resource in the case of download of a new resource. Note that identical resources mean ones which represent the same contents even with different formats or file entities.

If it is determined that update of the resource should be reflected, information of the updated resource is sent in step S3504 to a device manager, i.e., the manager PC 3 when the device is a peripheral device such as the printer 6 or 7 or the function composite type copying machine 8 or 9, and to a client PC user, i.e., the client PC 4 or 5 when the device is the client PC 4 or 5.

The notification method uses e-mail, file transfer, or the like. In this embodiment, this notification processing is executed by the server 2. Alternatively, the downloader 502 may communicate with the server 2 to acquire management information, determine the presence/absence of a device on which update of the resource should be reflected, and notify an associated device of this. In this case, the manager PC 3 notifies a peripheral device of the update, and, for example, the notification is displayed on the display.

Update notification of a resource clarifies a resource which should be matched between the printers 6 and 7, the function composite type copying machines 8 and 9, or the client PCs 4 and 5. This implements centralized, unitary management of resources.

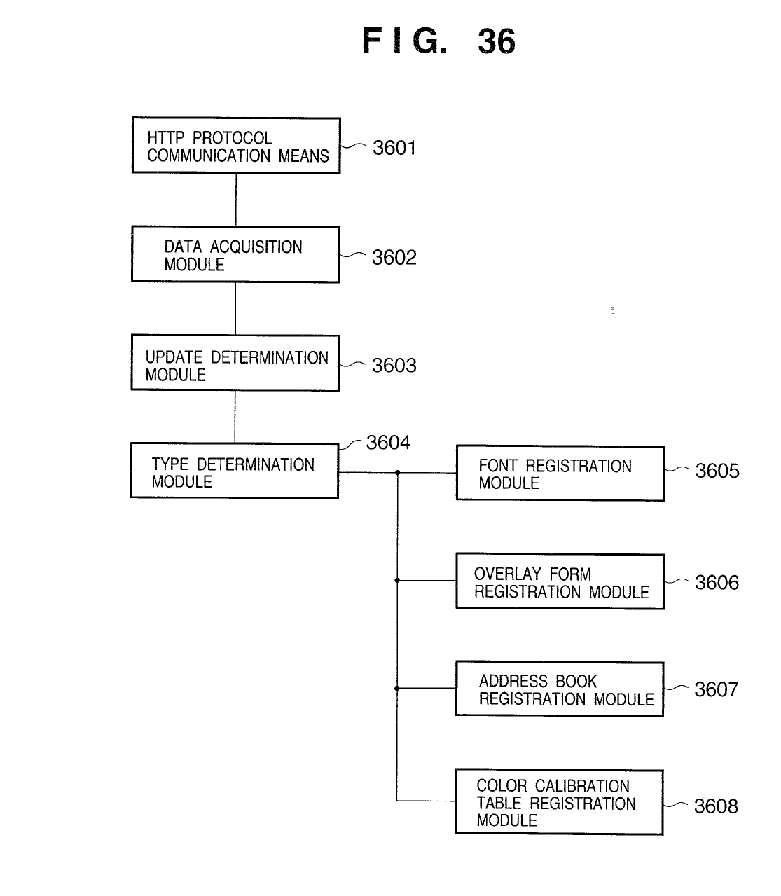

FIG. 36 is a view showing the configuration of the client module 603 which automatically updates a resource of the client PC 4 or 5 on the basis of a file concerning an updated resource that is supplied from the server when the resource is updated.

This mode is installed in the client PC 4 or 5 and processes a file received via the Web browser 602.

A communication module 3601 periodically communicates with the Web server 303 by http. A data acquisition module 3602 receives data from the Web server 303. The received data is usually archived data containing management information and a file entity.

A data update determination module 3603 determines whether data received via the Web browser 602 is different from data registered in the client PC 4 or 5, and if they are different, displays the message indicating this.

If the data are different, a file type determination module 3604 separates the received file into management information and a file entity, and determines the type of the file on the basis of the management information. For this purpose, the management information contains, e.g., the type of file, the file name, and the file size.

If the file type represents a font, the file type determination module 3604 calls a font registration module 3605. If the file type represents an overlay form, the file type determination module 3604 calls an overlay form registration module 3606. If the file type represents an address book, the file type determination module 3604 calls an address book registration module 3607. If the file type represents a color calibration table, the file type determination module 3604 calls a color calibration table registration module 3608.

The font registration module 3605 registers a received font in a client PC. The overlay form registration module 3606 registers a received overlay form in an overlay form processing application. When no overlay processing application is installed, this overlay form registration module 3606 does not perform any processing. The address book registration module 3607 registers a received address book after converting it into the format of a registration destination, e.g., e-mail management software or a FAX driver. The color calibration table registration module 3608 registers a received file in a printer driver for performing image processing.

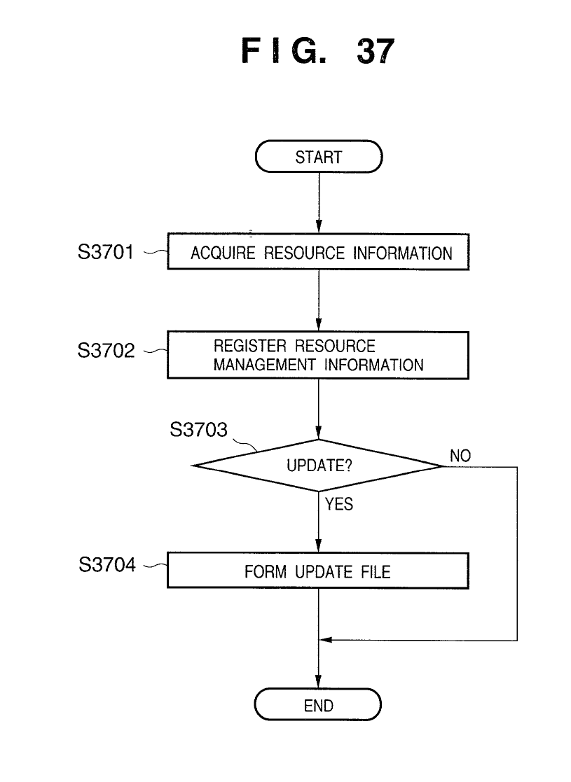

FIG. 37 is a flow chart showing an operation in the server 2 when a resource is updated and an identical resource in the client PC 4 or 5 is to be automatically updated.

In step S3701, information about a resource downloaded to a device via the downloader 502 is acquired by the communication module 708.

In step S3702, the acquired information is registered in management information. Details of registration are the same as in step S3502.

In step S3703, the presence/absence-of a device which downloaded an identical resource to the acquired resource is checked. “Identical resource” means one that represents the same contents even with a different format or file entity.

If it is determined that an identical resource was downloaded, and a device of interest is the client PC 4 or 5, an archived file of management information and a file entity is formed for the client PC in step S3704. The formed file is acquired by the client module 603 shown in FIG. 36, and the resource of the client PC 4 or 5 is automatically updated.

This automatic update of a resource prevents the problem that a printing result from the client PC 4 or 5 is different from data confirmed on the PC.

A case wherein entity data of an updated resource is saved in association with management information will be explained.

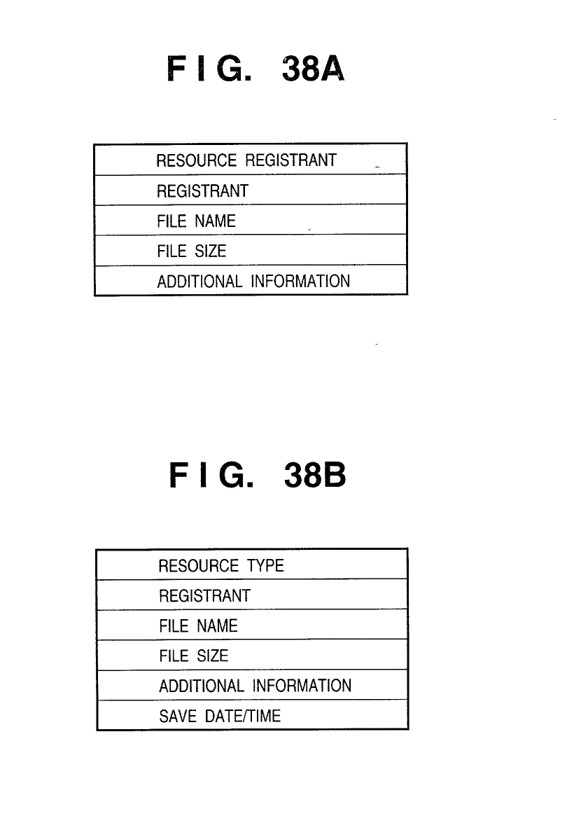

FIG. 38A shows registered-resource information data formed for each resource. Additional information includes information for specifying a resource, e.g., a version, a typeface for a font, or a form name for a form. FIG. 38B shows data saved when the status of each resource is changed. In this embodiment, the pieces of information in FIGS. 38A and 38B are set for each peripheral device.

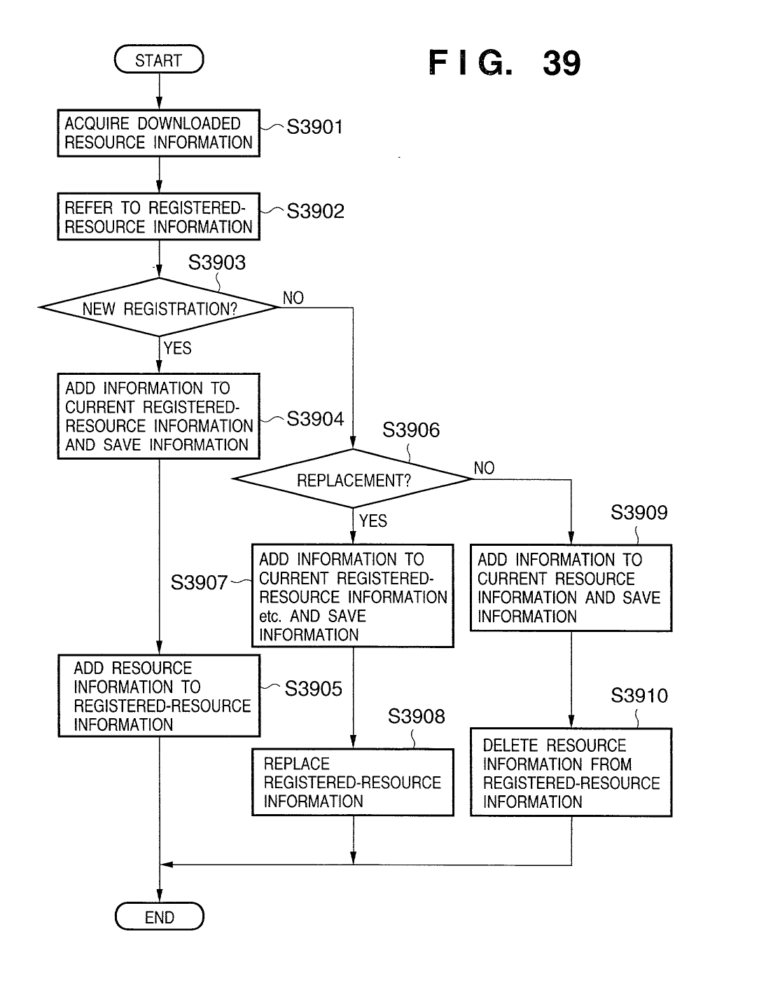

FIG. 39 is a flow chart showing data save operation in the server 2 when each resource is updated via the downloader 502. Data save operation will be described with reference to FIG. 39.

In step S3901, information for specifying a peripheral device and resource download information corresponding to registered-resource information data via the downloader 502 are acquired.

In step S3902, registered-resource information data of a peripheral device as a download destination is referred to.

In step S3903, whether the resource is newly registered, replaced, or deleted is determined based on the information via the downloader 502 and the registered-resource information data. If the resource is newly registered, processing in step S3904 and subsequent steps is done; if not, processing in step S3906 and subsequent steps is done.

In step S3904, all the registered-resource information data of the peripheral device are saved by adding the save date and time. In step S3905, information is added to the registered-resource information of the peripheral device.

If the resource is determined in step S3906 to be replaced and registered, the entity file of a corresponding resource and data obtained by adding the save date and time to registered-resource information data to be replaced are saved in step S3907. In step S3908, the registered-resource information data is replaced.

If the resource is determined in step S3906 to be deleted, the entity file of the resource and data obtained by adding the save date and time to registered-resource information data to be deleted are saved in step S3909. In step S3910, the registered-resource information data is deleted.

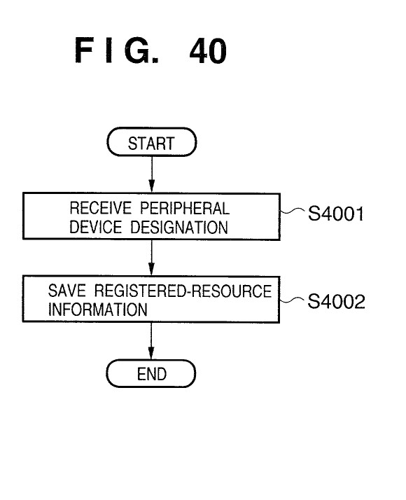

FIG. 40 is a flow chart showing data save operation when a resource status is saved in units of peripheral devices in the server 2. Data save operation will be described with reference to FIG. 40.

In step S4001, a list of peripheral devices is displayed on the display or the like, and a designation of a peripheral device whose resource status is to be saved is received. In step S4002, registered-resource information of the designated peripheral device is saved after adding the save date and time. Resource data may be saved only when a designation is received.

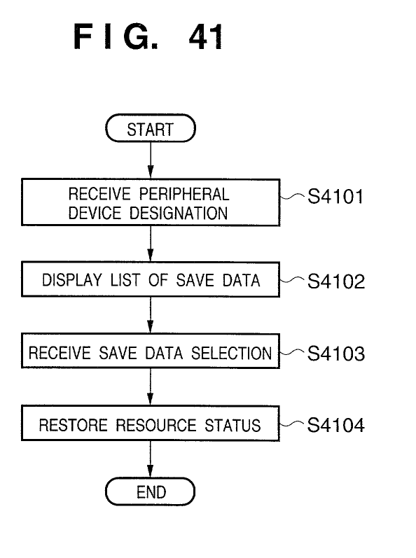

FIG. 41 is a flow chart showing resource status restoration processing in the server 2. Resource status restoration processing will be described with reference to FIG. 41.

In step S4101, a list of peripheral devices is displayed, and a designation of a peripheral device whose resource status is to be restored is received.

In step S4102, a list of the resource type of data saved in resource update, the save date and time, and the like, and pieces of information in units of device types saved in accordance with designations is displayed.

In step S4103, a designation of an individual resource to be restored or of a save date and time is received. In step S4104, the resource status is restored. Restoration can be achieved by transferring files concerning the resource via the manager PC 3 to a peripheral device, a client PC, or the like.

A resource registration status at an arbitrary point can be easily restored by holding log data when a registered resource is changed in units of resources or in units of devices or when save of the status is designated.

<Second Embodiment>

The system in FIG. 1 gives the server 2 the function of a file server, but the file server may be independent.

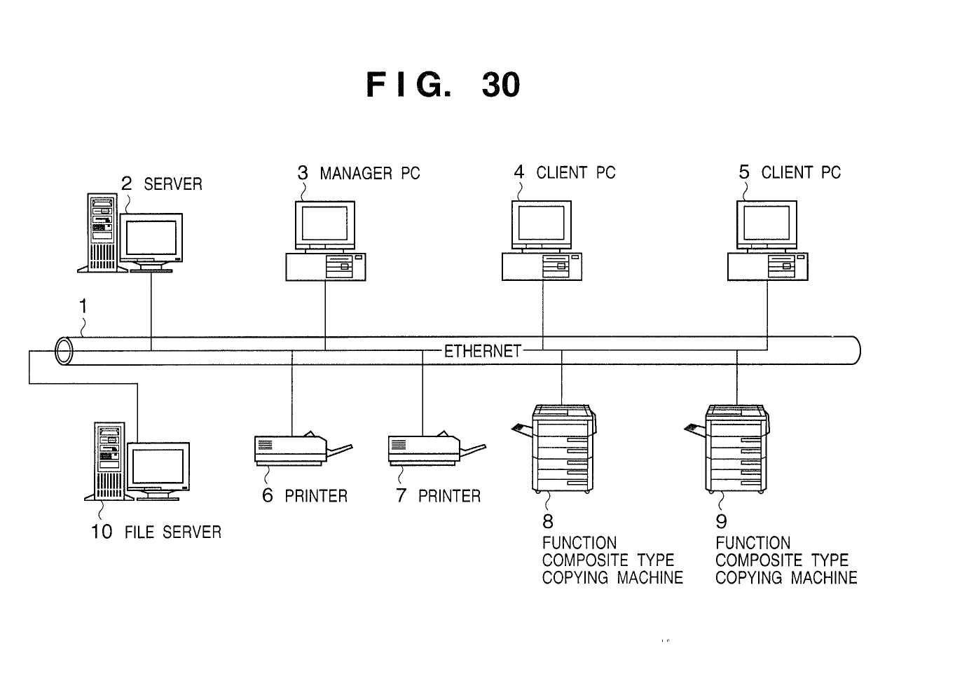

FIG. 30 is a view showing a system when the file server is independent in the system of FIG. 1. The system of FIG. 30 will be described though a description thereof partially overlaps the system of FIG. 1.

In FIG. 30, a network 1 uses Ethernet. However, LocalTalk or the like can also be used. In this embodiment, “network” means one or a plurality of means (protocols) which implement information exchange by the combination of electrical signals, by using physical cables and the electrical signals propagating on these cables. Usually, “network” is a general term of these means.

A server 2 has various functions such as a Web server function, and plays a main role in this embodiment. A manager personal computer (a personal computer will be simply referred to as a PC hereinafter) 3 gives designations to the server and peripheral devices. Client PCs 4 and 5 are PCs connected to the network 1, which are used by general users. Note that the manager PC 3 can also be used as a client PC.

Printers 6 and 7 are connected to the network 1 to receive printing instructions from the client PCs 4 and 5 and perform printing in accordance with the instructions. Function composite type copying machines 8 and 9 can be used as a copying machine, printer, scanner, and facsimile apparatus by using one or the combination of a plurality of functions, e.g., a copying function, image scanner function, printer function, and facsimile function.

A file server 10 normally holds a file shared by the server 2, the manager PC 3, and the like.

The operation of the system in FIG. 30 will be described below.

The server 2 periodically communicates with the printers 6 and 7 and the function composite type copying machines 8 and 9, and monitors the statuses of these devices and the settings of their software. The manager PC 3 changes the settings of these devices and changes their software or resources used by the software.

Pieces of designation information from the manager PC 3 are collected as pieces of information in the server 2 or held as files in the file server 10. The client PCs 4 and 5 receive the information from the server 2 or receive the files from the file server 10.

The server 2 has a communication module 708 using http. The manager PC 3 and the client PCs 4 and 5 can acquire information of the server 2 by using a Web browser 602 and can give designations to the server 2.

When receiving designation from the manager PC 3 or the client PC 4 or 5, the server 2 uses information which the server 2 has or files which the file server 10 holds, and returns the information or the files to the manager PC 3 or the client PC 4 or 5. Depending on the contents of the information, the server 2 acquires information from the printer 6 or 7 or the function composite type copying machine 8 or 9 and returns the information to the manager PC 3 or the client PC 4 or 5. Alternatively, the server 2 performs setting of the printers 6 and 7 and the function composite type copying machines 8 and 9.

The manager PC 3 has a downloader and can download software or resources used by the software to the printers 6 and 7 and the function composite type copying machines 8 and 9. Examples of the software are printing control firmware and network control firmware of these devices. In addition to these kinds of firmware, the function composite type copying machines 8 and 9 have, e.g., scanner control firmware, facsimile control firmware, copying machine firmware, panel operation firmware, image management software, and address management software.

Examples of the resources used by the software are fonts, external characters, overlay forms, calibration tables, address information used by the address management software, and facsimile numbers. The files of the software and resources are held in the file server 10.

The client PCs 4 and 5 hold software (e.g., drivers) for accessing and using the printers 6 and 7 and the function composite type copying machines 8 and 9, and resources (client PC resources) used by the software.

Examples of the software of the client PCs 4 and 5 are a printer driver for using a printer, a scanner driver for using a scanner, a facsimile driver for using a facsimile apparatus, copying machine utility software for controlling a copying machine, a network driver for using a network, a Web browser, and application software. Examples of the resources used by the software are client PC fonts corresponding to printer fonts, address information used by the facsimile driver, printing data used when color calibration is performed, and overlay images used in preview.

In the system of FIG. 30, the set contents, software, and resources used by the software of the printer 6 can be reflected on the other devices, i.e., the printer 7 and the function composite type copying machines 8 and 9. Analogously, the set contents, software, and resources used by the software of the function composite type copying machine 8 can be reflected on the function composite type copying machine 9 and the printers 6 and 7.

If these device types have functional differences, only functions common to these device types are reflected. However, information of a convertible resource can be reflected after conversion. Furthermore, information concerning these device types on the client PC 4 can be reflected on the client PC 5. These processes are implemented by exchanging information via the server 2 and the file server 10.

The set contents of the printers 6 and 7 and the function composite type copying machines 8 and 9 can be changed not only by designations from the manager PC 3 but also by designations from operation panels of these devices and from the client PC 4 or 5. If change information must be accurately transferred to the client PC 4 or 5, the printers 6 and 7 and the function composite type copying machines 8 and 9 are constantly inquired when the client PC 4 or 5 gives display designation or the like, and information at the inquiry timing can be returned to the client PC 4 or 5. If no strict accuracy is necessary, information held in the server 2 or in the file server 10 can be used.

The file server 10 receives and sends files, and if necessary manages them by communicating with the server 2, the manager PC 3, and the client PCs 4 and 5 via the network.

This system adopts one server and one manager PC, but the use of a separated file server allows easy management of files and information even if pluralities of servers and manager PCs exist. That is, the file server 10 can hold information shared in the system, if necessary can send information or files to each server or each manager PC, and can receive and manage information or files from them.

Update notification and automatic update of a resource or save and restoration of resource registration information can be implemented even in an environment in which the file server is separated. In this case, entity data of a resource may be saved in the file server 10.

The preferred embodiments of the present invention have been described above. However, the object of the present invention can also be achieved by supplying a storage medium storing program codes of software for implementing the functions of the above embodiments to a system or an apparatus, and reading out and executing the program codes stored in the storage medium by a computer (or a CPU or MPU) of the system or apparatus. In this case, the program codes read out from the storage medium implement the functions of the above embodiment, and the storage medium storing these program codes constitutes the present invention. Also, besides the functions of the above embodiment are implemented by executing the readout program codes by the computer, the present invention includes a case where an OS (Operating System) or the like running on the computer performs a part or the whole of actual processing in accordance with designations by the program codes and thereby implements the functions of the above embodiment.

Furthermore, the present invention includes a case where, after the program codes read from the storage medium are written in a memory of a function extension board inserted into the computer or of a function extension unit connected to the computer, a CPU or the like of the function extension board or function extension unit performs a part or the whole of actual processing in accordance with designations by the program codes and thereby implements the functions of the above embodiment.

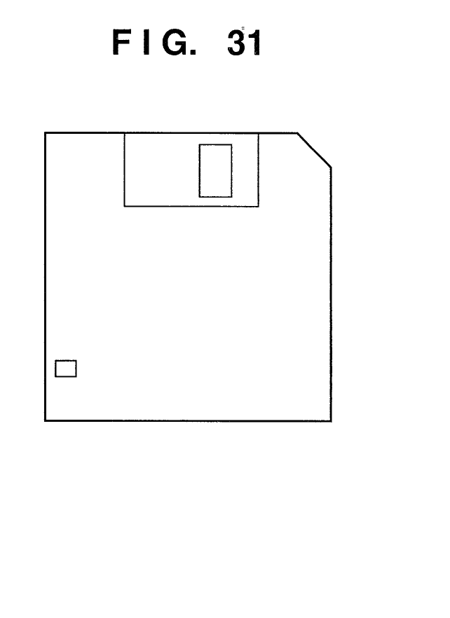

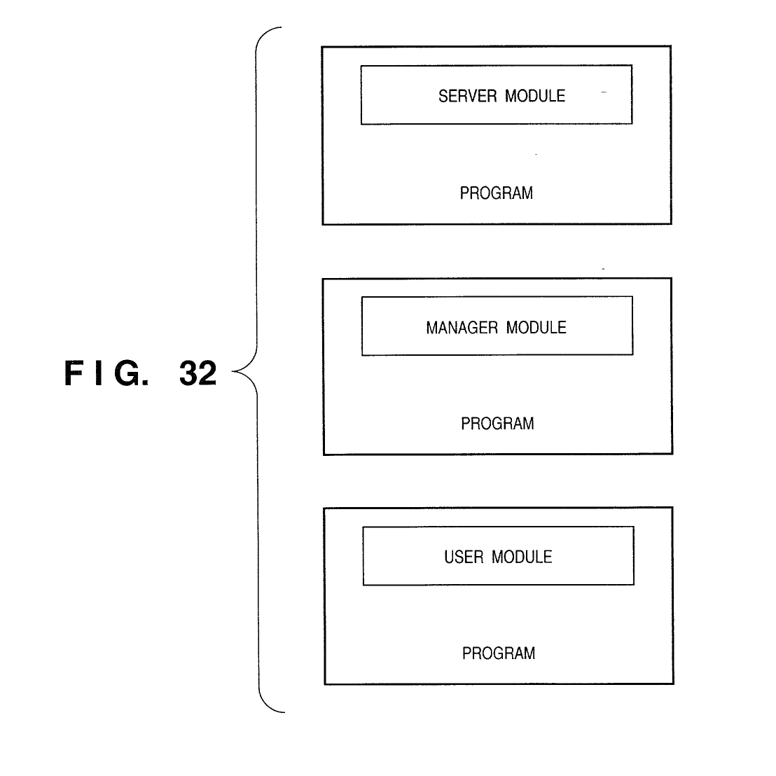

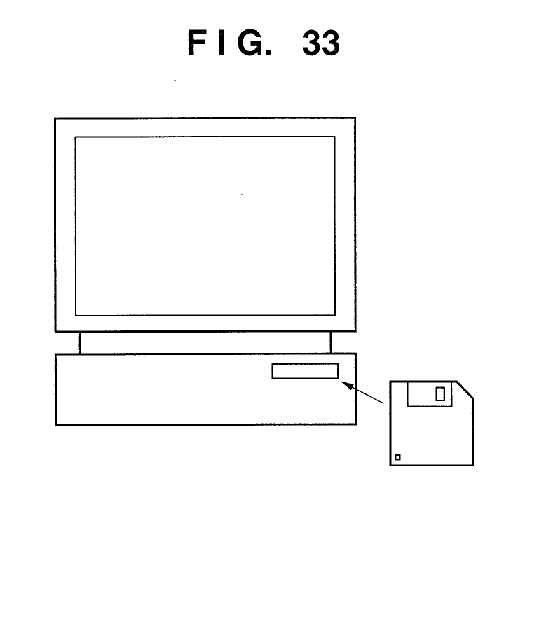

FIG. 31 is a view showing a floppy disk as an example of the storage medium for storing the program. FIG. 32 is a view showing program modules to be recorded on the floppy disk. FIG. 33 is a view showing a process of loading the program modules recorded in the floppy disk into a server, manager personal computer, or user personal computer. As is apparent from these drawings, the present invention can be executed by a computer such as a workstation or personal computer by using a portable storage medium.

As many apparently widely different embodiments of the present invention can be made without departing from the spirit and scope thereof, it is to be understood that the invention is not limited to the specific embodiments thereof except as defined in the appended claims.

What is claimed is:

1. A network system comprising a plurality of peripheral devices, a resource updating apparatus for updating resources used by said peripheral devices and a resource manager apparatus for managing the resources being respectively connected via a network, wherein said resource manager apparatus comprises
means for storing setting information indicating relation between each of said peripheral devices and resources set thereon,
means for, when resources of one of said peripheral devices are updated, searching for the others concerning the updated resource on the basis of the setting information, and
means for notifying said resource updating apparatus that resources of said searched peripheral device should be updated.

2. The system according to claim 1, wherein said resource updating apparatus comprises
means for, when resources are updated, searching for said peripheral devices concerning the updated resource on the basis of the setting information.

3. The system according to claim 1, wherein resource updating apparatus updates resources of said searched peripheral device according to the notification.

4. The system according to claim 1, wherein the notification is performed by transferring e-mail or a file.

5. The system according to claim 1, wherein said resource manager apparatus comprises
saving means for saving the updated resource and at least one of a type of data, a registrant, a size, a data name, and a save date and time which concern the updated resource.

6. The system according to claim 5, wherein
said saving means saves the updated resource according to user designation.

7. The system according to claim 5, wherein
said saving means saves log information indicating log concerning update of the resource.

8. The system according to claim 7, wherein
said resource manager apparatus, according to designation for restoring a resource, sends the designated resource to said resource updating apparatus.

9. The system according to claim 1, wherein
the setting information includes information indicating said peripheral devices on which resources are set for each resource.

10. The system according to claim 1, wherein
the setting information includes information indicating resources set on said peripheral devices for each of said peripheral devices.

11. The system according to claim 1, wherein
update of the resource includes at least one of setting of a new resource, replacement of the resource, and deletion of the resource.

12. The system according to claim 1, wherein
the resources include at least one of a font, an external character, a form, a calibration table, and address information.

13. The system according to claim 1, wherein
said peripheral devices include at least one of a printer, a scanner, a copying machine, and a facsimile apparatus.

14. A resource manager apparatus communicating with a plurality of peripheral devices and a resource updating apparatus for updating resources used by said peripheral devices and managing the resources, comprising
means for storing setting information indicating relation between each of said peripheral devices and resources set thereon,
means for, when resources of one of said peripheral devices are updated, searching for the others concerning the updated resource on the basis of the setting information, and
means for notifying said resource updating apparatus that resources of said searched peripheral device should be updated.

15. The resource manager apparatus according to claim 14, further comprising
saving means for saving the updated resource and at least one of a type of data, a registrant, a size, a data name, and a save date and time which concern the updated resource.

16. The resource manager apparatus according to claim 15, wherein
said saving means saves the updated resource according to user designation.

17. The resource manager apparatus according to claim 14, wherein
the setting information includes information indicating said peripheral devices on which resources are set for each resource.

18. The resource manager apparatus according to claim 14, wherein
update of the resource includes at least one of setting of a new resource, replacement of the resource, and deletion of the resource.

19. The resource manager apparatus according to claim 14, wherein
the resources include at least one of a font, an external character, a form, a calibration table, and address information.

20. The resource manager apparatus according to claim 14, wherein
said peripheral devices include at least one of a printer, a scanner, a copying machine, and a facsimile apparatus.

21. A resource managing method executed on a system comprising a plurality of peripheral devices and a resource updating apparatus for updating resources used by said peripheral devices being respectively connected, comprising the steps of
searching, when resources of one of said peripheral devices are updated, for the others concerning the updated resource on the basis of setting information indicating relation between each of said peripheral devices and resources set thereon, and
notifying said resource updating apparatus that resources of said searched peripheral device should be updated.

22. The method according to claim 21, further comprising
saving step of saving the updated resource and at least one of a type of data, a registrant, a size, a data name, and a save date and time which concern the updated resource.

23. The method according to claim 21, wherein
the setting information includes information indicating said peripheral devices on which resources are set for each resource.

24. A recording medium which records a resource managing program for executed on a system comprising a plurality of peripheral devices and a resource updating apparatus for updating resources used by said peripheral devices being respectively connected, said resource managing program allowing a computer to execute the steps of
searching, when resources of one of said peripheral devices are updated, for the others concerning the updated resource on the basis of setting information indicating relation between each of said peripheral devices and resources set thereon, and
notifying said resource updating apparatus that resources of said searched peripheral device should be updated.

25. The recording medium according to claim 24, wherein said resource managing program allows the computer to further execute
saving step of saving the updated resource and at least one of a type of data, a registrant, a size, a data name, and a save date and time which concern the updated resource.

26. The recording medium according to claim 24, wherein
the setting information includes information indicating said peripheral devices on which resources are set for each resource.

27. A resource managing program for executed on a system comprising a plurality of peripheral devices and a resource updating apparatus for updating resources used by said peripheral devices being respectively connected, said resource managing program allowing a computer to execute the steps of
searching, when resources of one of said peripheral devices are updated, for the others concerning the updated resource on the basis of setting information indicating relation between each of said peripheral devices and resources set thereon, and
notifying said resource updating apparatus that resources of said searched peripheral device should be updated.

28. The resource managing program according to claim 27, allowing the computer to further execute
saving step of saving the updated resource and at least one of a type of data, a registrant, a size, a data name, and a save date and time which concern the updated resource.

29. The resource managing program according to claim 27, wherein
the setting information includes information indicating said peripheral devices on which resources are set for each resource.

30. A network system comprising a peripheral device, computers, a resource updating apparatus for updating resources used by said peripheral device or said computers and a resource manager apparatus for managing the resources being respectively connected via a network, wherein said resource manager apparatus comprises
means for storing setting information indicating relation between each of said computers and resources set thereon,
means for, when resources of said peripheral device or one of said computers are updated, searching for the other computers concerning the updated resource on the basis of the setting information, and
means for notifying the searched computer that resources have been updated.

31. The system according to claim 30, wherein the searched computer updates resources according to the notification.

32. The system according to claim 30, wherein the notification is performed by transferring e-mail or a file.

33. The system according to claim 30, wherein said resource manager apparatus comprises
saving means for saving the updated resource and at least one of a type of data, a registrant, a size, a data name, and a save date and time which concern the updated resource.

34. The system according to claim 33, wherein
said saving means saves the updated resource according to user designation.

35. The system according to claim 33, wherein
said saving means saves log information indicating log concerning update of the resource.

36. The system according to claim 35, wherein
said resource manager apparatus, according to designation for restoring a resource, sends the designated resource to said resource updating apparatus.

37. The system according to claim 30, wherein
the setting information includes information indicating said peripheral devices on which resources are set for each resource.

38. The system according to claim 30, wherein
the setting information includes information indicating resources set on said computers for each of said computers.

39. The system according to claim 30, wherein
update of the resource includes at least one of setting of a new resource, replacement of the resource, and deletion of the resource.

40. The system according to claim 30, wherein
the resources include at least one of a font, an external character, a form, a calibration table, and address information.

41. The system according to claim 30, wherein
said peripheral devices include at least one of a printer, a scanner, a copying machine, and a facsimile apparatus.

42. A resource manager apparatus communicating with a peripheral device, computers, and a resource updating apparatus for updating resources used by said peripheral device or said computers and managing the resources, comprising
means for storing setting information indicating relation between each of said computers and resources set thereon,
means for, when resources of said peripheral device or one of said computers are updated, searching for the other computers concerning the updated resource on the basis of the setting information, and
means for notifying the searched computer that resources have been updated.

43. A resource managing method executed on a system comprising a peripheral device, computers, and a resource updating apparatus for updating resources used by said peripheral device or said computers being respectively connected, comprising the steps of
storing setting information indicating relation between each of said computers and resources set thereon,
searching, when resources of said peripheral device or one of said computers are updated, for the other computers concerning the updated resource on the basis of the setting information, and
notifying the searched computer that resources have been updated.

44. A recording medium which records a resource managing program for executed on a system comprising a peripheral device, computers, and a resource updating apparatus for updating resources used by said peripheral device or said computers being respectively connected, said resource managing program allowing a computer to execute the steps of
storing setting information indicating relation between each of said computers and resources set thereon,
searching, when resources of said peripheral device or one of said computers are updated, for the other computers concerning the updated resource on the basis of the setting information, and
notifying the searched computer that resources have been updated.

45. A resource managing program for executed on a system comprising a peripheral device, computers, and a resource updating apparatus for updating resources used by said peripheral device or said computers being respectively connected, said resource managing program allowing a computer to execute the steps of
storing setting information indicating relation between each of said computers and resources set thereon,
searching, when resources of said peripheral device or one of said computers are updated, for the other computers concerning the updated resource on the basis of the setting information, and
notifying the searched computer that resources have been updated.

46. An information processing system in which a server, and devices including pluralities of client terminals and peripheral devices are connected to a network, comprising:
storage holding means for storing and holding resource information concerning resources of said devices on the network;
first update means for updating a resource in accordance with a request from a client terminal;
second update means for updating the resource information in said storage holding means when said first update means updates the resource to a peripheral device;
comparison means for comparing resource information stored and held in said storage holding means with resource information which another client terminal has; and
third update means for updating the resource of said another client terminal on the basis of a comparison result of said comparison means.

47. The system according to claim 46, wherein
said first update means comprises determination means for determining whether the resource exists in said server, and
the resource is registered in said peripheral device from said server or client terminal in accordance with a result of said determination means.

48. The system according to claim 47, wherein when said determination means determines that the resource does not exist in said server, the resource is converted to a status usable by said client terminal.

49. The system according to claim 46, wherein
said first update means comprises search means for searching for a peripheral device which can register a resource, and
the resource to said peripheral device which can register the resource is updated in accordance with a result of said search means.

50. The system according to claim 46, wherein said comparison means performs comparison by using, as the resource information, a resource type, information for specifying a resource, and a device type to be registered.

51. The system according to claim 46, wherein said third update means determines a resource type from the resource information and updates a resource of the determined type.

52. The system according to claim 46, wherein the resources include a font, an external character, and a form.

53. The system according to claim 46, wherein the comparison is performed on said server.

54. The system according to claim 46, wherein the comparison is performed on said client terminal.

55. A method of controlling an information processing system in which a server, and devices including pluralities of client terminals and peripheral devices are connected to a network, comprising:
the storage holding step of storing and holding, in a predetermined storage medium, resource information concerning resources of the devices on the network;
the first update step of updating a resource in accordance with a request from a client terminal;
the second update step of updating the resource information in the storage medium when the resource to a peripheral device is updated in the first update step;
the comparison step of comparing resource information stored and held in the storage holding step with resource information which another client terminal has; and
the third update step of updating the resource of the another client terminal on the basis of a comparison result in the comparison step.

56. The method according to claim 55, wherein
the first update step comprises the determination step of determining whether the resource exists in the server, and
the resource is registered in the peripheral device from the server or the client terminal in accordance with a result in the determination step.

57. The method according to claim 55, wherein when the resource is determined in the determination step not to exist in the server, the resource is converted to a status usable by the client terminal.

58. The method according to claim 55, wherein
the first update step comprises the search step of searching for a peripheral device which can register a resource, and
the resource to the peripheral device which can register the resource is updated in accordance with a result in the search step.

59. The method according to claim 55, wherein the comparison step comprises the step of performing comparison by using, as the resource information, a resource type, information for specifying a resource, and a device type to be registered.

60. The method according to claim 55, wherein the third update step comprises the step of determining a resource type from the resource information and updating a resource of the determined type.

61. The method according to claim 55, wherein the resources include a font, an external character, and a form.

62. The method according to claim 55, wherein the comparison is performed on the server.

63. The method according to claim 55, wherein the comparison is performed on the client terminal.

64. A recording medium which stores a program code functioning as an information processing system in which a server, and devices including pluralities of client terminals and peripheral devices are connected to a network, wherein the program code includes:
a program code of the storage holding step of storing and holding, in a predetermined storage medium, resource information concerning resources of the devices on the network;
a program code of the first update step of updating a resource in accordance with a request from a client terminal;
a program code of the second update step of updating the resource information in the storage medium when the resource to a peripheral device is updated in the first update step;
a program code of the comparison step of comparing resource information stored and held in the storage holding step with resource information which another client terminal has; and
a program code of the third update step of updating the resource of the another client terminal on the basis of a comparison result in the comparison step.
